(19) United States
(12) Patent Application Publication
(10) Pub. No.: US 2010/0257561 A1
(43) Pub. Date: Oct. 7, 2010

(54) Surfer's Paradise

(75) Inventors: Jonathan Maissel, Modi'in (IL); Ezra Darshan, Beit Shemesh (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Middlesex (GB)

(21) Appl. No.: 11/991,819

(22) PCT Filed: Sep. 22, 2005
(86) PCT No.: PCT/IL05/01019

§ 371 Date: Jun. 3, 2008

(51) Int. Cl. H04N 5/445

(52) U.S. Cl. 725/41

(57) ABSTRACT

A system for a viewer to navigate television programming using a control, the television programming being view-able on a display device having a screen, the system comprising a program guide module to manage program guide information for a plurality of program items for a plurality of channels, the program items including a plurality of current and future scheduled programs, the program guide information including a plurality of links to a plurality of program item representations associated with the program items, a navigation control module to receive program selection instructions from the viewer, via the control, in order for the viewer to surf among the program item representations of the current and future programs, and a program item display module to display a currently selected program item representation which occupies a majority of the screen of the display device. Related apparatus and methods are also described.

### FIELD OF THE INVENTION

The present invention relates to television, and in particular, relates to presentation of current, future and past programming on television.

### BACKGROUND OF THE INVENTION

By way of introduction, there are many systems and methods of program navigation.

The “Now and Next Banner” is a text only banner which is part of many electronic program guides (EPGs). The banner is displayed on top of the currently viewed program. Viewers are able to see which programs are currently being shown on another channel and then tune to the chosen program. Additionally, the banner typically shows the title of the program which is to be shown next. Furthermore, by pressing other buttons, the banner typically shows details of programs that will be shown over the next couple of days.

In 2002, Alex Taylor and Richard Harper released a paper entitled “Switching on to switch off: An analysis of routine TV watching habits and their implications for electronic program guide design” from the Digital World Research Centre, School of Human Sciences, University of Surrey, GU2 7XH, UK, by Taylor, A. S., & Harper, R. (2002). This paper is found on the Internet at: //research.microsoft.com/˜ast/files/IDTV.pdf.

In the above mentioned paper, Taylor and Harper show the sequence of methods people generally use to make program selection. Taylor and Harper theorize that viewers begin with surfing as it requires the least effort (or thought) and is part of the act of viewing, as opposed to referring to newspaper or EPG listings, which require more effort and a transition of context. In other words, people have to step away from the act of watching TV and carry out a different task. In the light of this, Taylor and Harper propose a simplified EPG that reduces the transition from watching TV to referring to a newspaper or EPG, by displaying thumbnails (rather than text) of the programs that are on now-and-next. Taylor and Harper also recommend just showing this information for the viewer's five favorite channels.

Time Warner Cable is working on a way to solve a channel surfer's nightmare of missing the start of a show. The new service, tentatively called “Startover”, will allow viewers to run back to the beginning of any program that is currently on the air. If launched, Startover would fall somewhere between the capability of a digital video recorder and video on demand for live TV. It would differ from a DVR in several ways. First, there would not be a way to fast-forward through commercials or programming. Second, unlike a DVR that stores hours of programs on a hard drive in a viewer's home, Startover would store shows currently on the air at the cable head-end. An icon would alert viewers to whether the service would apply.

The following references are also believed to represent the state of the art:

US Published Patent Application 2005/0002649 of Boyle, et al.;

US Published Patent Application 2003/0097657 of Zhou, et al.;

US Published Patent Application 2003/0177495 of Needham, et al.;

US Published Patent Application 2002/0124071 of Proehl, et al;

US Published Patent Application 2003/0093792 of Labeeb, et al.;

US Published Patent Application 2004/0003399 of Cooper;

US Published Patent Application 2002/0133820 of Arai, et al.;

UK Published Patent Application GB2377578 of British Broadcasting Corporation;

UK Published Patent Application GB2343075 of Sony United Kingdom;

European Published Patent Application EP1223757 of Metabyte Networks, Inc.;

European Published Patent Application EP1024661 of Hughes Electronics Corporation;

European Patent EP0830787 to United Video Properties, Inc.;

European Patent EP0594351 to AT&T Corp.;

U.S. Pat. No. 6,323,911 to Schein, et al.;

U.S. Pat. No. 6,414,720 to Tsukidate, et al,;

U.S. Pat. No. 6,563,515 to Reynolds, et al.;

U.S. Pat. No. 5,751,282 to Girard, et al.;

U.S. Pat. No. 5,945,987 to Dunn;

U.S. Pat. No. 5,585,866 to Miller, et al.;

U.S. Pat. No. 6,542,169 to Marshall, et al.;

U.S. Pat. No. 6,205,485 to Kikinis, et al.;

U.S. Pat. No. 5,914,746 to Matthews, III et al.;

PCT Published Patent Application WO 02/080552 of Koninklijke Philips Electronics N.V.;

PCT Published Patent Application WO 01/39494 of America Online, Inc.;

PCT Published Patent Application WO 00/40021 of Koninklijke Philips Electronics N.V.;

PCT Published Patent Application WO 96/41477 of TV Guide on Screen;

“Specifying a component model for building dynamically reconfigurable distributed systems” by X. Chen, published by Springer-Verlag, Germany; and

Brief Article in Broadcasting & Cable (journal 12, volume 133) entitled “TV Guide Channel gets new look”.

The disclosures of all references mentioned above and throughout the present specification, as well as the disclosures of all references mentioned in those references, are hereby incorporated herein by reference.

### SUMMARY OF THE INVENTION

The present invention seeks to provide an improved program navigation system.

The system of the present invention, in preferred embodiments thereof, allows a viewer to surf among program item representations of current scheduled programs, future scheduled programs and previous scheduled programs of real and virtual channels. Viewer recorded programs, broadcaster pushed programs and video-on-demand (VOD) programs are typically among the programs available for surfing. The future scheduled programs, the broadcaster pushed programs and the VOD programs are typically represented by promotional representations such as promotional video clips and/or still images. The current scheduled programs are represented by live broadcasts and the viewer recorded programs are typically represented by the actual recorded program. Each program item representation preferably occupies 100% of the screen. In addition, a transition screen is optionally briefly displayed prior to display of the selected program item representation. Optionally, a text banner is superimposed over the program item representation screen to convey additional information to the viewer.

The system of the present invention, in preferred embodiments thereof, also includes self-adapting virtual channels, whereby one or more new virtual channels are preferably created to receive some of the program items of the original virtual channel when the original virtual channel reaches a predetermined size.

The system of the present invention, in preferred embodiments thereof, also includes presentation of recorded program items; virtual channels for price ranges, episodes and currently viewed program; sorting recorded program items within virtual channels; and sorting of the real and virtual channels within an EPG.

There is thus provided in accordance with a preferred embodiment of the present invention a system for a viewer to navigate television programming using a control, the television programming being viewable on a display device having a screen, the system including a program guide module to manage program guide information for a plurality of program items for a plurality of channels, the program items including a plurality of current scheduled programs and a plurality of future scheduled programs, the program guide information including a plurality of links to a plurality of program item representations associated with the program items, a navigation control module to receive program selection instructions from the viewer, via the control, in order for the viewer to surf, for each of the channels, among the program item representations of one of the current scheduled programs and at least two of the future scheduled programs, and a program item display module to display a currently selected one of the program item representations so that the currently selected one program item representation occupies a majority of the screen of the display device.

Further in accordance with a preferred embodiment of the present invention the program item representations include a plurality of currently broadcast videos for the current scheduled programs and a plurality of promotional representations for the future scheduled programs.

Still further in accordance with a preferred embodiment of the present invention at least one of the promotional representations is a promotional video associated with a corresponding one of the future scheduled programs.

Additionally in accordance with a preferred embodiment of the present invention each of the promotional representations includes at least one of a promotional video clip and a still image, the promotional video clip and the still image being associated with a corresponding one of the future scheduled programs.

Moreover in accordance with a preferred embodiment of the present invention the currently selected one program item representation occupies at least 70% of the screen of the display device.

Further in accordance with a preferred embodiment of the present invention the currently selected one program item representation occupies at least 90% of the screen of the display device.

Still further in accordance with a preferred embodiment of the present invention the program item display module is adapted to display only one of the program item representations at a time.

Additionally in accordance with a preferred embodiment of the present invention the program items include at least one previous scheduled program being associated with one of the program item representations, and the navigation control module being adapted to receive the program selection instructions from the viewer, via the control, in order for the viewer to surf among the program item representations of one of the current scheduled programs and the at least one previous scheduled program.

Moreover in accordance with a preferred embodiment of the present invention the at least one previous scheduled program includes a recorded program.

Further in accordance with a preferred embodiment of the present invention the channels include a virtual channel.

Still further in accordance with a preferred embodiment of the present invention the program items of the virtual channel include at least one video-on-demand program.

Additionally in accordance with a preferred embodiment of the present invention each of the program items has a viewing time slot and a start time, and in the virtual channel, the program items includes a plurality of overlapping program items such that the viewing time slot of a first one of the program items overlaps with the viewing time slot of a second one of the program items in the virtual channel.

Moreover in accordance with a preferred embodiment of the present invention the program item display module is adapted to display the overlapping program items based on a start time of the overlapping program items.

Further in accordance with a preferred embodiment of the present invention the program item display module is adapted to display the overlapping program items based on an alphabetical sorting of the overlapping program items.

Still further in accordance with a preferred embodiment of the present invention the program item display module is adapted to display an on-screen-display including a choice of which of the overlapping program items to currently display.

Additionally in accordance with a preferred embodiment of the present invention, the system includes a transition screen generator to generate a transition screen for display before display of each of the program item representations.

Moreover in accordance with a preferred embodiment of the present invention the transition screen includes a text banner including a channel number of a currently selected one of the channels.

Further in accordance with a preferred embodiment of the present invention the transition screen includes a text banner including a channel name of a currently selected one of the channels.

Still further in accordance with a preferred embodiment of the present invention the transition screen includes a text banner including a title of a currently selected one of the program items.

Additionally in accordance with a preferred embodiment of the present invention the transition screen includes a text banner including at least one of a start time, an end time and a duration of a currently selected one of the program items.

Moreover in accordance with a preferred embodiment of the present invention the transition screen includes a text banner including an episode number of a currently selected one of the program items.

Further in accordance with a preferred embodiment of the present invention the transition screen includes a text banner including a viewed/not viewed/partially viewed status of a currently selected one of the program items.

Still further in accordance with a preferred embodiment of the present invention the transition screen includes a text banner including a when recorded indicator of a currently selected one of the program items.

Additionally in accordance with a preferred embodiment of the present invention the transition screen includes a text banner including credits of a currently selected one of the program items.

Moreover in accordance with a preferred embodiment of the present invention the transition screen includes a text banner including a genre of a currently selected one of the program items.

Further in accordance with a preferred embodiment of the present invention the transition screen includes a text banner including a plot outline of a currently selected one of the program items.

Still further in accordance with a preferred embodiment of the present invention the transition screen includes a text banner including at least one of a booking option and a recording option of a currently selected one of the program items, so that the viewer can select at least one of booking and recording the currently selected one program item.

Additionally in accordance with a preferred embodiment of the present invention the transition screen includes a text banner including a price of a currently selected one of the program items.

Moreover in accordance with a preferred embodiment of the present invention the transition screen includes a text banner including a rating of a currently selected one of the program items.

Further in accordance with a preferred embodiment of the present invention transition screen generator is adapted to display the transition screen for a predetermined time period which can be overridden by viewer input via the control such that the transition screen is removed prior to completion of the predetermined time period.

Still further in accordance with a preferred embodiment of the present invention, the system includes a banner generator to generate a text banner for display with each of the program item representations.

Additionally in accordance with a preferred embodiment of the present invention, the system includes a promotional video grabber to identify and record a currently broadcast for immediate display promotional video for use as one of the promotional representations.

Moreover in accordance with a preferred embodiment of the present invention the control is a remote control.

There is also provided in accordance with still another preferred embodiment of the present invention a system for a viewer to navigate television programming using a control, the system including a program guide module to manage program guide information for a plurality of program items for a plurality of channels, the program items including a plurality of current scheduled programs, a plurality of future scheduled programs and a plurality of previous scheduled programs, a navigation control module to receive program item selection instructions from the viewer, via the control, in order for the viewer to move among the program items, and a program item display module to display the program items sorted by the channels, the previous scheduled programs being displayed with the channels from which the previous scheduled programs were scheduled, the previous scheduled programs being displayed such that non-time adjacent previous scheduled programs of one of the channels are displayed substantially adjacent to each other.

Further in accordance with a preferred embodiment of the present invention the channels include a plurality of real channels and a virtual channel, the program item display module being adapted to display one of the previous scheduled programs, both in the real channel and in the virtual channel.

Still further in accordance with a preferred embodiment of the present invention the channels including a plurality of virtual channels, the program item display module being adapted to display one of the previous scheduled programs in two of the virtual channels.

Additionally in accordance with a preferred embodiment of the present invention the control is a remote control.

There is also provided in accordance with still another preferred embodiment of the present invention a system for a viewer to navigate television programming, the system including a program guide module to manage program guide information for a plurality of program items for a plurality of channels including a virtual channel, the program items including a plurality of episodes of a series, and a channel management module to manage the virtual channel such that all the program items displayed in the virtual channel are the episodes of the series.

Moreover in accordance with a preferred embodiment of the present invention the program items include at least one recorded item, the recorded item being a recorded item of one of the episodes of the series, the virtual channel including the recorded item.

There is also provided in accordance with still another preferred embodiment of the present invention a system for a viewer to navigate television programming, the system including a program guide module to manage program guide information for a plurality of program items for a plurality of channels including a virtual channel, the program items having associated prices, the prices of the program items defining a first price range, and a channel management module to manage the virtual channel such that the prices of all the program items displayed in the virtual channel are within a second price range which is narrower than the first price range.

There is also provided in accordance with still another preferred embodiment of the present invention a system for a viewer to navigate television programming, the system including a program guide module to manage program guide information for a plurality of program items for a plurality of channels, the channels including a virtual channel, and a channel management module to manage the virtual channel such that all the program items displayed in the virtual channel are associated with a program characteristic of a currently viewed one of the program items.

There is also provided in accordance with still another preferred embodiment of the present invention a system for a viewer to navigate television programming, the system including a program guide module to manage program guide information for a plurality of program items for a plurality of channels, the program items including a plurality of current scheduled programs, a plurality of future scheduled programs and a plurality of recorded programs, a channel management module to manage a first virtual channel such that all the program items displayed in the first virtual channel have a first program characteristic, the program items displayed in the first virtual channel including one of the recorded programs and at least one of one of the current scheduled programs, and one of the future scheduled programs, and a virtual channel monitor module to monitor a size of the first virtual channel, so that, when the size grows to a predetermined size, the channel management module creates a second virtual channel to receive some of the program items of the first virtual channel, all the program items displayed in the second virtual channel having a second program characteristic which is different from the first program characteristic.

Further in accordance with a preferred embodiment of the present invention the second program characteristic is a sub-category of the first program characteristic.

Still further in accordance with a preferred embodiment of the present invention the virtual channel monitor module is adapted to monitor a number of the recorded programs displayed in the first virtual channel, so that, when the number of the recorded programs grows to a predetermined size, the channel management module creates the second virtual channel.

Additionally in accordance with a preferred embodiment of the present invention, when the channel management module creates the second virtual channel to receive some of the program items of the first virtual channel, the size of the first virtual channel is reduced.

Moreover in accordance with a preferred embodiment of the present invention at least one of the first program characteristic and the second program characteristic is a genre of the program items.

Further in accordance with a preferred embodiment of the present invention at least one of the first program characteristic and the second program characteristic is an attribute of the program items.

There is also provided in accordance with still another preferred embodiment of the present invention a system for a viewer to navigate television programming, the system including a program guide module to manage program guide information for a plurality of program items for a plurality of channels, the program items including a plurality of current scheduled programs, a plurality of future scheduled programs and a plurality of recorded programs, a channel management module to manage a first virtual channel including some of the program items, the program items displayed in the first virtual channel including at least one of the recorded programs, at least one of the current scheduled programs and at least one of the future scheduled programs, and a virtual channel monitor module to monitor a size of the first virtual channel, so that, when the size falls below a predetermined size, the channel management module adds the program items of the first virtual channel to a more general second virtual channel.

Still further in accordance with a preferred embodiment of the present invention the more general second virtual channel is an existing virtual channel.

Additionally in accordance with a preferred embodiment of the present invention the more general second virtual channel is a newly created virtual channel to merge therein the program items of the first virtual channel and the program items of another one of the virtual channels.

There is also provided in accordance with still another preferred embodiment of the present invention a system for a viewer to navigate television programming, the system including a program guide module to manage program guide information for a plurality of program items for a plurality of channels, the channels including a virtual channel, each of the program items having a viewing time slot, the viewing time slot of a first one of the program items overlapping with the viewing time slot of a second one of the program items, and a program item display module to display the virtual channel such that the first program item and the second program item share a single expandable slot in the virtual channel.

Moreover in accordance with a preferred embodiment of the present invention, the system includes a list box display module to display a listbox including the first program item and the second program item when the =expandable slot is selected by the viewer for expansion.

There is also provided in accordance with still another preferred embodiment of the present invention a system for a viewer to navigate television programming, the system including a program guide module to manage program guide information for a plurality of program items for a plurality of channels, the program items including a plurality of recorded, current scheduled and future scheduled programs, and a channel management module to order the recorded programs of at least one of the channels for display based on at least one of the following a release date of the recorded programs, a viewed/not-viewed/partially-viewed status of the recorded programs, an estimated viewer personal preference, and an alphabetical sorting.

Further in accordance with a preferred embodiment of the present invention the order of the recorded programs in the virtual channel is based on the release date of the recorded programs.

Still further in accordance with a preferred embodiment of the present invention the order of the recorded programs in the virtual channel is based on the viewed/not-viewed/partially-viewed status of the recorded programs.

Additionally in accordance with a preferred embodiment of the present invention the order of the recorded programs in the virtual channel is based on the alphabetical sorting.

Moreover in accordance with a preferred embodiment of the present invention the order of the recorded programs in the virtual channel is based on the estimated viewer personal preference.

Further in accordance with a preferred embodiment of the present invention the channels include a virtual channel, the at least one channel including the virtual channel.

There is also provided in accordance with still another preferred embodiment of the present invention a system for a viewer to navigate television programming, the system including a program guide module to manage program guide information for a plurality of program items for a plurality of channels including a virtual channel, and a channel management module to order at least some of the program items of the virtual channel for display based on a sorting method which is dependent upon a characteristic of the virtual channel.

Still further in accordance with a preferred embodiment of the present invention the characteristic is a genre of the virtual channel.

There is also provided in accordance with still another preferred embodiment of the present invention a system for a viewer to navigate television programming, the system including a program guide module to manage program guide information for a plurality of program items for a plurality of channels including a plurality of real channels, and a channel management module to order at least one of the channels for display among the others of the channels at least one of the following a content of the at least one channel, a frequency of viewing of the program items of the at least one channel, a frequency of viewing at a time of day, an alphabetical sorting by a name of the at least one channel, and an estimated viewer personal preference.

Additionally in accordance with a preferred embodiment of the present invention the order of the at least one channel among the other channels is the content of the at least one channel.

Moreover in accordance with a preferred embodiment of the present invention the order of the at least one channel among the other channels is the frequency of viewing of the program items of the at least one channel.

Further in accordance with a preferred embodiment of the present invention the order of the at least one channel among the other channels is the frequency of viewing at a time of day.

Still further in accordance with a preferred embodiment of the present invention the order of the at least one channel among the other channels is alphabetical sorting by the name of the at least one channel.

Additionally in accordance with a preferred embodiment of the present invention the order of the at least one channel among the other channels is the estimated viewer personal preference.

Moreover in accordance with a preferred embodiment of the present invention the channels include a virtual channel, the at least one channel including the virtual channel.

Further in accordance with a preferred embodiment of the present invention the channel management module is adapted to order the virtual channel for display among the real channels.

Still further in accordance with a preferred embodiment of the present invention the channels include other virtual channels, the channel management module being adapted to order the virtual channel for display only among the other virtual channels.

There is also provided in accordance with still another preferred embodiment of the present invention a system for a viewer to navigate television programming, the system including a program guide module to manage program guide information for a plurality of program items for a plurality of channels including a plurality of real channels and at least one virtual channel, the program items including a plurality of current scheduled programs, a plurality of future scheduled programs and a plurality of previous scheduled programs, and a program item display module to display one of the previous scheduled programs, both in the real channel and in the virtual channel.

There is also provided in accordance with still another preferred embodiment of the present invention a system for a viewer to navigate television programming, the system including a program guide module to manage program guide information for a plurality of program items for a plurality of channels including a plurality of real channels and a plurality of virtual channels, the program items including a plurality of current scheduled programs, a plurality of future scheduled programs and a plurality of previous scheduled programs, and a program item display module to display one of the previous scheduled programs in two of the virtual channels.

There is also provided in accordance with still another preferred embodiment of the present invention a method for a viewer to navigate television programming using a control, the television programming being viewable on a display device having a screen, the method including managing program guide information for a plurality of program items for a plurality of channels, the program items including a plurality of current scheduled programs and a plurality of future scheduled programs, the program items being represented by a plurality of program item representations, the program guide information including a plurality of links to the program item representations, receiving program selection instructions from the viewer, via the control, in order for the viewer to surf, for each of the channels, among the program item representations of one of the current scheduled programs and at least two of the future scheduled programs, and displaying a currently selected one of the program item representations so that the currently selected one program item representation occupies a majority of the screen of the display device.

There is also provided in accordance with still another preferred embodiment of the present invention a method for a viewer to navigate television programming using a control, the method including managing program guide information for a plurality of program items for a plurality of channels, the program items including a plurality of current scheduled programs, a plurality of future scheduled programs and a plurality of previous scheduled programs, receiving program item selection instructions from the viewer, via the control, in order for the viewer to move among the program items, and displaying the program items sorted by the channels, the previous scheduled programs being displayed with the channels from which the previous scheduled programs were scheduled, the previous scheduled programs being displayed such that non-time adjacent previous scheduled programs of one of the channels are displayed substantially adjacent to each other.

There is also provided in accordance with still another preferred embodiment of the present invention a method for a viewer to navigate television programming, the method including managing program guide information for a plurality of program items for a plurality of channels including a virtual channel, the program items including a plurality of episodes of a series, and managing the virtual channel such that all the program items displayed in the virtual channel are the episodes of the series.

There is also provided in accordance with still another preferred embodiment of the present invention a method for a viewer to navigate television programming, the method including managing program guide information for a plurality of program items for a plurality of channels including a virtual channel, the program items having associated prices, the prices of the program items defining a first price range, and managing the virtual channel such that the prices of all the program items displayed in the virtual channel are within a second price range which is narrower than the first price range.

There is also provided in accordance with still another preferred embodiment of the present invention a method for a viewer to navigate television programming, the method including managing program guide information for a plurality of program items for a plurality of channels, the channels including a virtual channel, and managing the virtual channel such that all the program items displayed in the virtual channel are associated with a program characteristic of a currently viewed one of the program items.

There is also provided in accordance with still another preferred embodiment of the present invention a method for a viewer to navigate television programming, the method including managing program guide information for a plurality of program items for a plurality of channels, the program items including a plurality of current scheduled programs, a plurality of future scheduled programs and a plurality of recorded programs, managing a first virtual channel such that all the program items displayed in the first virtual channel have a first program characteristic, the program items displayed in the first virtual channel including one of the recorded programs and at least one of one of the current scheduled programs, and one of the future scheduled programs, and monitoring a size of the first virtual channel, so that, when the size grows to a predetermined size, the channel management module creates a second virtual channel to receive some of the program items of the first virtual channel, all the program items displayed in the second virtual channel having a second program characteristic which is a sub-category of the first program characteristic.

There is also provided in accordance with still another preferred embodiment of the present invention a method for a viewer to navigate television programming, the method including managing program guide information for a plurality of program items for a plurality of channels, the program items including a plurality of current scheduled programs, a plurality of future scheduled programs and a plurality of recorded programs, managing a first virtual channel including some of the program items, the program items displayed in the first virtual channel including at least one of the recorded programs, at least one of the current scheduled programs and at least one of the future scheduled programs, and monitoring a size of the first virtual channel, so that, when the size falls below a predetermined size, the program items of the first virtual channel are added to a more general second virtual channel.

There is also provided in accordance with still another preferred embodiment of the present invention a method for a viewer to navigate television programming, the method including managing program guide information for a plurality of program items for a plurality of channels, the channels including a virtual channel, each of the program items having a viewing time slot, the viewing time slot of a first one of the program items overlapping with the viewing time slot of a second one of the program items, and displaying the virtual channel such that the first program item and the second program item share a single expandable slot in the virtual channel.

There is also provided in accordance with still another preferred embodiment of the present invention a method for a viewer to navigate television programming, the method including managing program guide information for a plurality of program items for a plurality of channels, the program items including a plurality of recorded, current and future scheduled programs, and ordering the recorded programs of at least one of the channels for display based on at least one of the following a release date of the recorded programs, a viewed/not-viewed/partially-viewed status of the recorded programs, an estimated viewer personal preference and an alphabetical sorting.

There is also provided in accordance with still another preferred embodiment of the present invention a method for a viewer to navigate television programming, the method including managing program guide information for a plurality of program items for a plurality of channels including a virtual channel, and ordering at least some of the program items of the virtual channel for display based on a sorting method which is dependent upon a characteristic of the virtual channel.

There is also provided in accordance with still another preferred embodiment of the present invention a method for a viewer to navigate television programming, the method including managing program guide information for a plurality of program items for a plurality of channels including a plurality of real channels, and ordering at least one of the channels for display among the others of the channels at least one of the following a content of the at least one channel, a frequency of viewing of the program items of the at least one channel, a frequency of viewing at a time of day, an alphabetical sorting by a name of the at least one channel, and an estimated viewer personal preference.

There is also provided in accordance with still another preferred embodiment of the present invention a method for a viewer to navigate television programming, the method including managing program guide information for a plurality of program items for a plurality of channels including a plurality of real channels and at least one virtual channel, the program items including a plurality of current scheduled programs, a plurality of future scheduled programs and a plurality of previous scheduled programs, and displaying one of the previous scheduled programs, both in the real channel and in the virtual channel.

There is also provided in accordance with still another preferred embodiment of the present invention a method for a viewer to navigate television programming, the method including managing program guide information for a plurality of program items for a plurality of channels including a plurality of real channels and a plurality of virtual channels, the program items including a plurality of current scheduled programs, a plurality of future scheduled programs and a plurality of previous scheduled programs, and displaying one of the previous scheduled programs in two of the virtual channels.

### BRIEF DESCRIPTION OF THE DRAWINGS

The present invention will be understood and appreciated more fully from the following detailed description, taken in conjunction with the drawings in which:

FIG. 1 is a simplified block diagram view of an electronic program guide system constructed and operative in accordance with a preferred embodiment of the present invention;

FIGS. 2-10 are partly pictorial, partly block diagram views of a viewer surfing through program items using the system of FIG. 1;

FIG. 11 is a simplified flow chart of a preferred method of operation of the electronic program guide system of FIG. 1;

FIG. 12 is partly pictorial, partly block, diagram illustrating the preferred method of operation of the system of FIG. 1;

FIG. 13 is a simplified view of a preferred embodiment of a transition screen banner for use with the system of FIG. 1;

FIG. 14 is a simplified flow chart of another aspect of the preferred method of operation of the electronic program guide system of FIG. 1;

FIGS. 15-17 are simplified views of electronic program guide grids constructed and operative in accordance with the preferred method of operation of FIG. 14;

FIG. 18 is a simplified flow chart of yet another aspect of the preferred method of operation of the electronic program guide system of FIG. 1;

FIGS. 19-20 are simplified views of electronic program guide grids constructed and operative in accordance with the preferred method of operation of FIG. 18;

FIG. 21 is a simplified flow chart of a further aspect of the preferred method of operation of the electronic program guide system of FIG. 1;

FIGS. 22-26 are simplified views of virtual channels constructed and operative in accordance with the preferred method of operation of FIG. 21;

FIG. 27 is a simplified flow chart of an additional aspect of the preferred method of operation of the electronic program guide system of FIG. 1; and

FIGS. 28-35 are simplified views of electronic program guide grids constructed and operative in accordance with the preferred method of operation of FIG. 27.

### DETAILED DESCRIPTION OF A PREFERRED EMBODIMENT

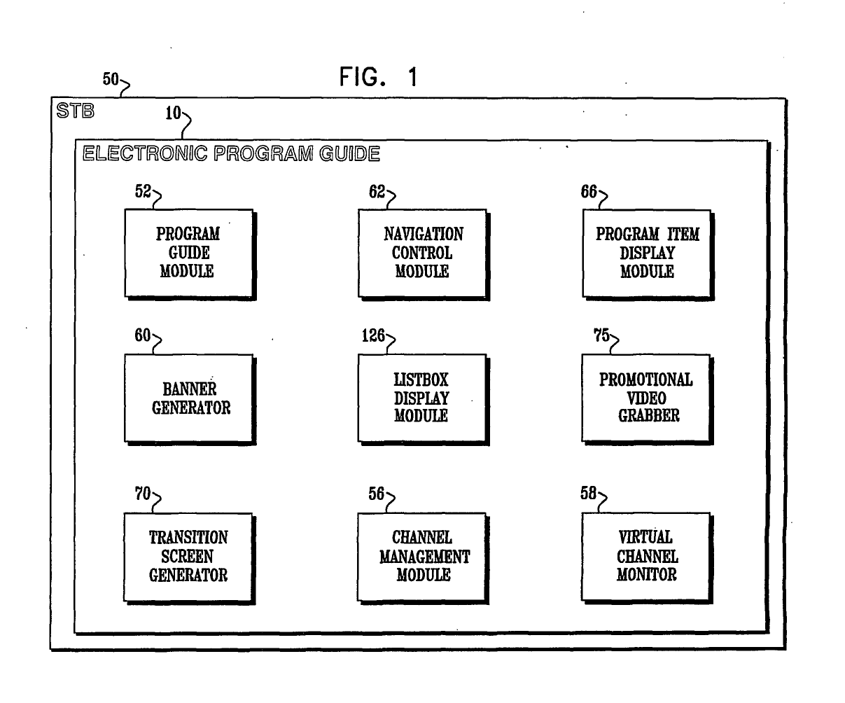

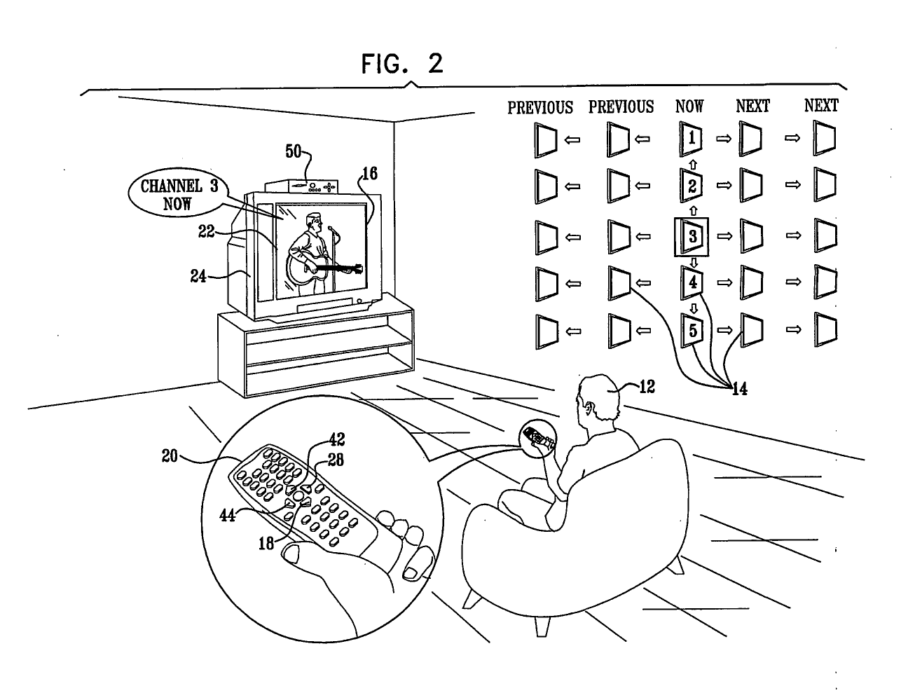

Reference is now made to FIG. 1. FIG. 1 is a simplified block diagram view of an electronic program guide system 10 constructed and operative in accordance with a preferred embodiment of the present invention. Before the elements of the electronic program guide system 10 are described in more detail, a preferred method of operation of the electronic program guide system 10 is described by way of an illustrated example with reference to FIGS. 2-10. FIGS. 2-10 are partly pictorial, partly block diagram views of a viewer 12 surfing through a plurality of program items 14 using the electronic program guide system 10 of FIG. 1.

Reference is now made to FIG. 2. The viewer 12 is currently viewing a full screen currently broadcast video 16 of channel 3 on a screen 22 of a display device 24. The viewer 12 decides to see what is being broadcast on another live channel.

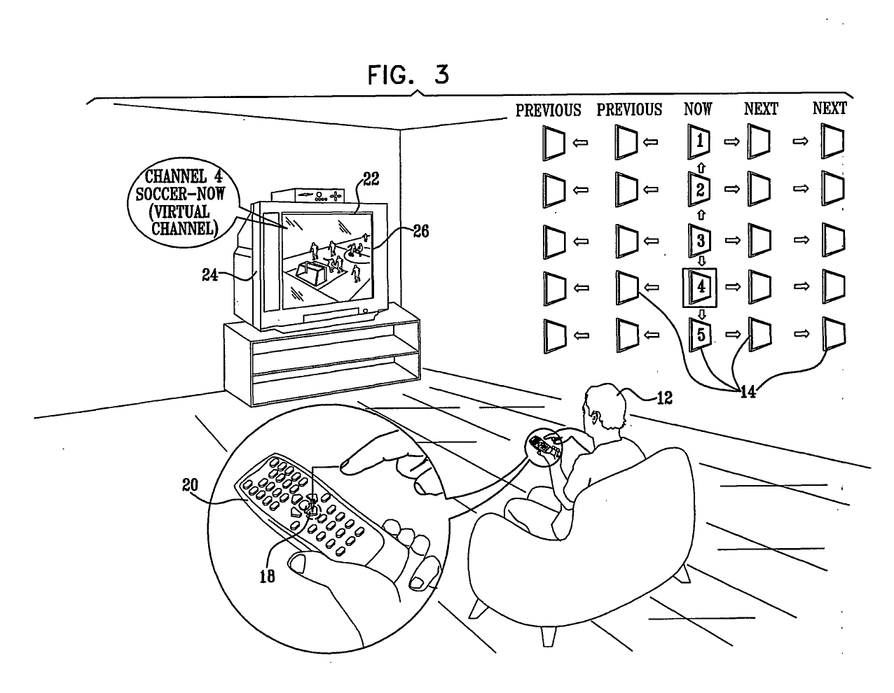

Reference is now made to FIG. 3. The viewer 12 presses, once, on a down key 18 of a remote control 20. The screen 22 of the display device 24 now shows a full screen currently broadcast video 26 of channel 4. Channel 4 is a virtual channel.

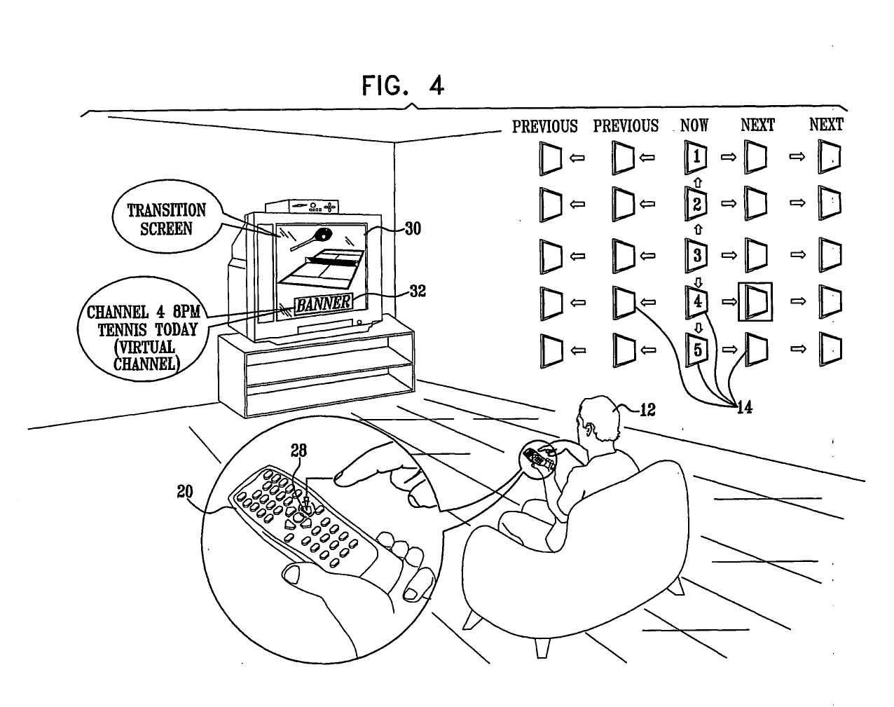

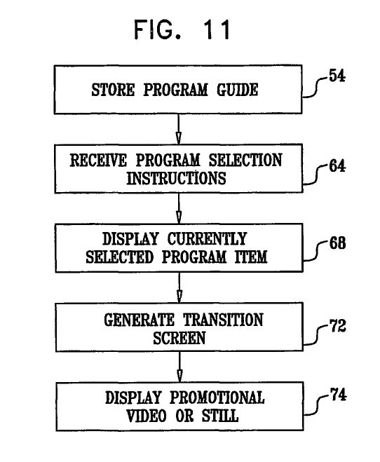

Reference is now made to FIG. 4. The viewer 12 wants to see what is going to be broadcast in the future on channel 4. Therefore, the viewer 12 presses a right key 28 of the remote control 20, thereby selecting a promotion of the next program on channel 4. First, a transition screen 30 is displayed for a few seconds. The transition screen 30 includes, or is superimposed by, a text banner 32 which conveys additional information about the selected program. Transition screens are explained in more detail with reference to FIG. 13.

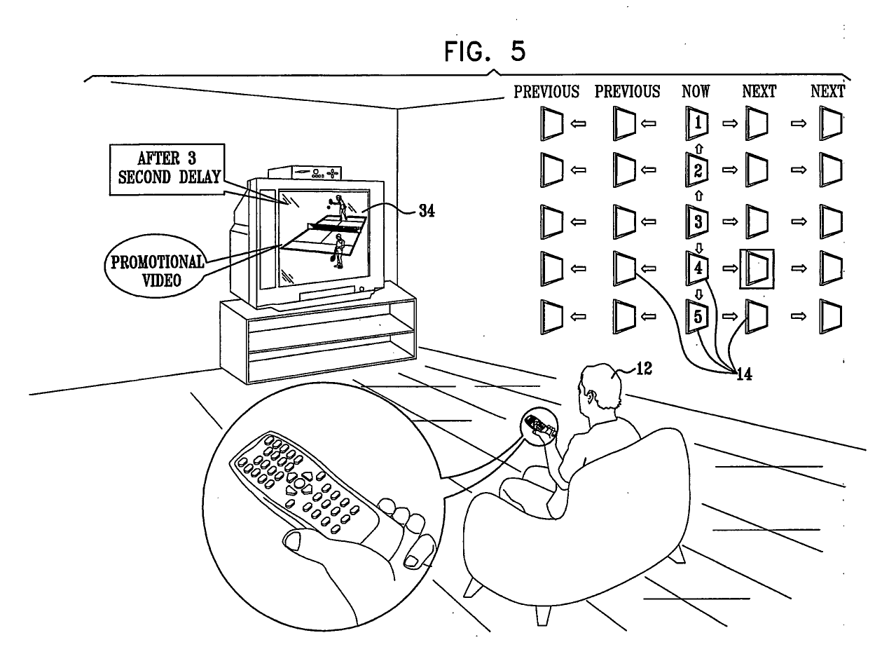

Reference is now made to FIG. 5. After a three second delay (or a similar short delay), the transition screen 30 (FIG. 4) is replaced by a full screen promotional video 34.

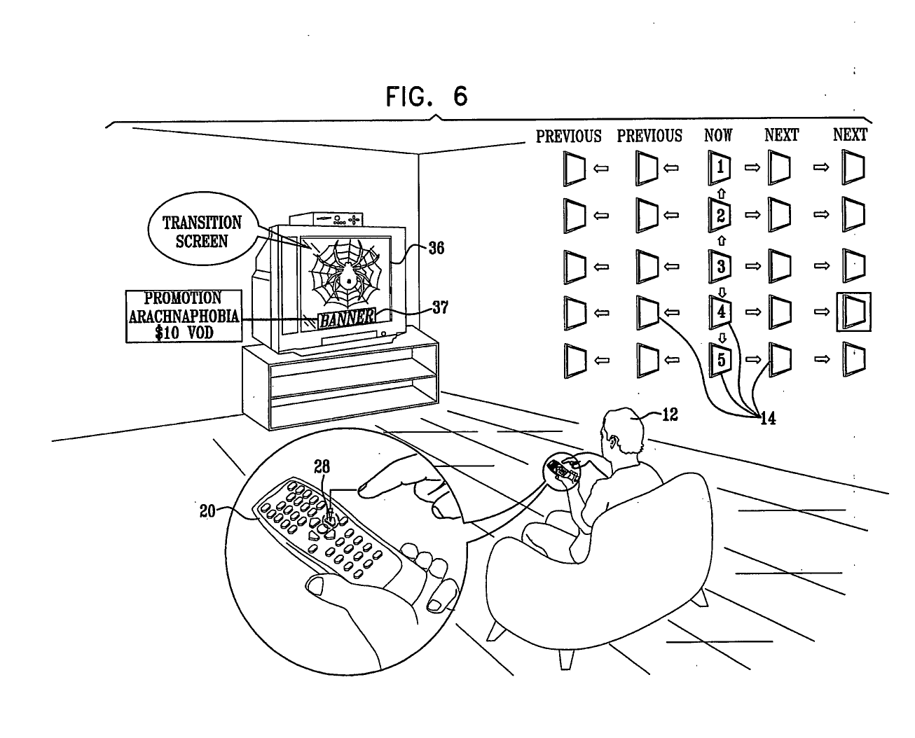

Reference is now made to FIG. 6. The viewer 12 then decides to surf further into the future, by pressing once on the right key 28 of the remote control 20. First, a transition screen 36 with a banner 37 is displayed for three seconds.

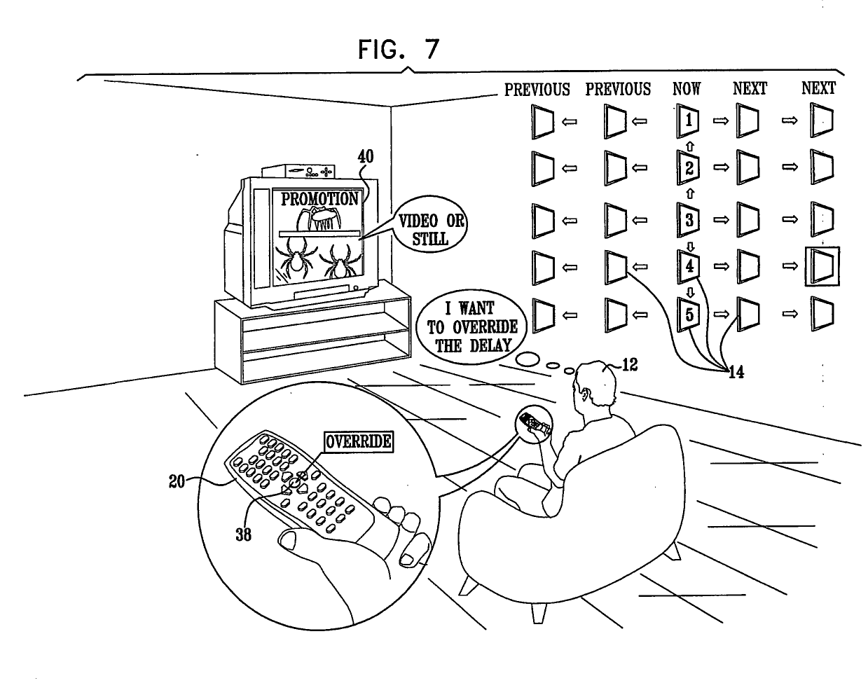

Reference is now made to FIG. 7. During the three second delay period, the viewer 12 becomes impatient with viewing the transition screen 36 (FIG. 6). Therefore, the viewer 12 presses on an override button 38 (or “select” button) of the remote control 20, thereby removing the transition screen 36 before the predetermined delay for the display of the transition screen 36 is completed. Now, the transition screen 36 is replaced by a full screen promotional video or promotional still 40 of the selected program item, which is a video-on-demand (VOD) item. VOD items are described in more detail with reference to FIGS. 1 and 11 below. When a promotional still 40 is used, the promotional still 40 typically includes booking and/or recording options (not shown). It should be noted that the override function simply removes the transition screen, but does not override the viewer's requirement to pay for viewing the actual VOD film; of course viewing the promotional video or still is free of charge.

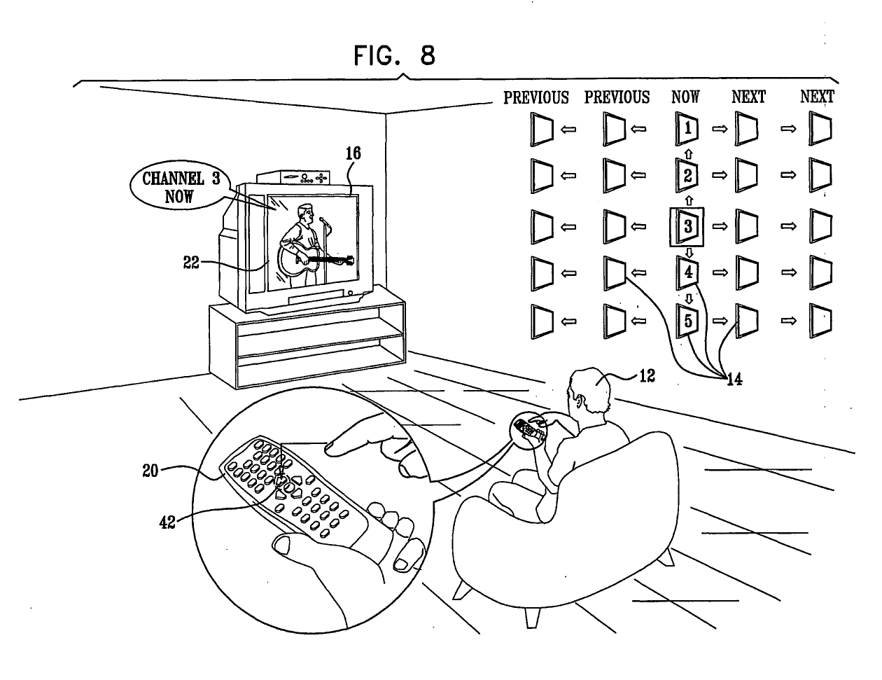

Reference is now made to FIG. 8. The viewer 12 now decides to surf back up to channel 3. Therefore, the viewer 12 presses, once, on an up key 42 of the remote control 20. The screen 22 now shows the full screen currently broadcast video 16 of channel 3.

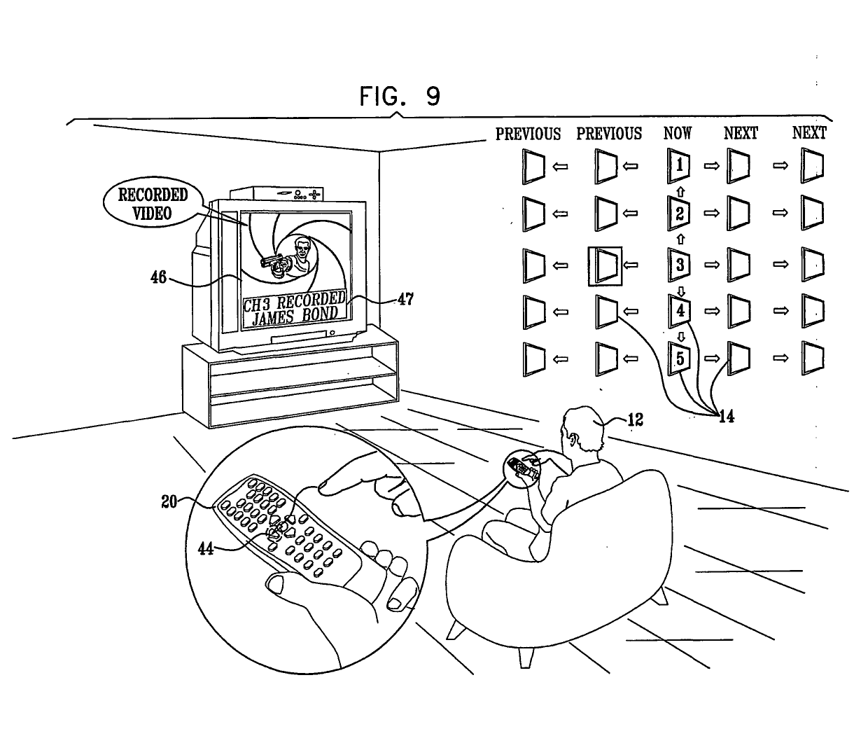

Reference is now made to FIG. 9. The viewer 12 now decides to surf back in time to see what items have been recorded on channel 3, as well as what broadcaster pushed programs are still available. Therefore, the viewer 12 presses on a left key 44 of the remote control 20 once, thereby displaying a James Bond movie 46 recorded earlier on channel 3. A text banner 47 is typically displayed over the movie 46 for three seconds, for example. Although no transition screen has been shown, it will be appreciated by those ordinarily skilled in the art that a transition screen can also been shown prior to showing the movie 46. In fact, in all the examples given above a transition screen is optional. For example, a transition screen may be used for all items; or a transition screen may only be used for future scheduled program items and not current scheduled program items and previous scheduled program items. It will be appreciated by those ordinarily skilled in the art that other suitable combinations are possible.

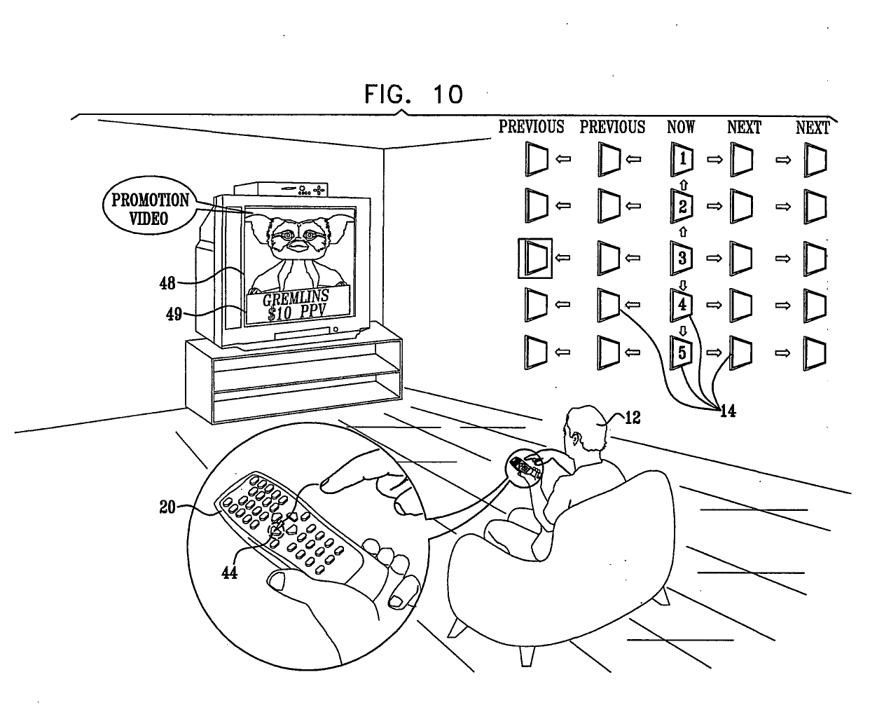

Reference is now made to FIG. 10. The viewer now decides to surf further back in time. Therefore, the viewer 12 presses, once, on the left key 44 of the remote control 20, thereby displaying a promotional video 48 of a pay-per-view (PPV), broadcaster pushed movie, having a text banner 49.

The electronic program guide system 10 is now described in more detail with reference to FIGS. 1, 2 and 11. FIG. 11 is a simplified flow chart of a preferred method of operation of the electronic program guide system 10 of FIG. 1. The electronic program guide system 10 allows the viewer 12 to navigate television programming using the remote control 20. The electronic program guide system 10 is typically implemented on a set-top box 50 (STB) (also known as an integrated receiver decoder (IRD). It will be appreciated by those ordinarily skilled in the art that the electronic program guide system 10 can be implemented on any other suitable device for example, but not limited to, a computer system. The electronic program guide system 10 preferably includes a program guide module 52 to manage program guide information for a plurality of program items for a plurality of channels (block 54). The program items typically include: current scheduled programs, future schedules programs and previous scheduled programs. Current scheduled programs typically include programs being broadcast now. Future scheduled programs typically include programs to be broadcast in the future. Previous scheduled programs typically include viewer recorded programs recorded on a recording device, for example, but not limited to, a personal video recorder (PVR), digital video recorder (DVR), or any suitable video recorder device. The recording device is typically implemented as part of the set-top box 50. However, it will be appreciated by those ordinarily skilled in the art that the recording device can be implemented as a device which is separate from the set-top box 50. Viewer recorded programs are typically displayed as previous scheduled programs to the left of the current scheduled programs.

Two special types of programs, namely, broadcaster pushed programs and VOD programs, are now described in more detail.

Broadcaster pushed programs are generally downloaded to, and stored in, the recording device, by the broadcaster. Typically, a section of a storage area of the recording device is reserved by the broadcaster for broadcaster pushed programs or other content. Broadcaster pushed programs are preferably classified as either previous or current or future scheduled programs depending on whether the time slot allotted by the broadcaster in the EPG is now in the past, is now current, or is still in the future. For example, a film was broadcaster pushed to the recording device at 4 am. The broadcaster advertises the film for viewing between 2 pm and 4 pm the same day. Therefore, at 6 am the film is seen as a “future” program. At 2 pm, the film is seen as a “current” program. At 6 pm, the film is now a previous scheduled program. It should be noted that broadcaster pushed programs may also be listed elsewhere, for example, but not limited to, a films for hire section rather than being part of the schedule or EPG grid.

Video-on-demand (VOD) program items are typically divided into two types.

The first type is a VOD item which is typically available for viewing at any time at the discretion of the viewer. Therefore, the first type of VOD program typically allows the viewer to stop, rewind, fast forward, and pause during viewing. The VOD item is stored in a remote server. The first type of VOD program is typically available over a cable or Internet Protocol (IP) network. The first type of VOD item generally forms part of the program items of an appropriate virtual channel or shown in a list of VOD programs according to category or genre, for example.

The second type of VOD item is typically broadcast repeatedly and very frequently over various real channels, for example, but not limited to, start broadcasting the same film every 15 minutes on channels 5 to 10. The second type of VOD item is typically known as near video-on-demand (NVOD). The second type of VOD item is frequently employed in non-cable systems, for example, but not limited to, satellite and terrestrial broadcast systems.

An NVOD item is typically classified as a current or future scheduled program in the EPG.

The channels preferably include real channels and one or more virtual channels.

The term “real channel”, in all of its grammatical forms, as used in the specification and claims, is defined as a channel in which the current and future scheduled program items are determined by a party other than the viewer 12, for example, but not limited to, the broadcaster or content aggregator of the channel.

The term “virtual channel”, in all of its grammatical forms, as used in the specification and claims, is defined as a channel in which the program items of the virtual channel are taken from one or more of the following: one or more real channels; other virtual channels; recorded programs and VOD programs, wherein the selection of individual program items of the virtual channel is independent of the broadcaster or content aggregator.

The electronic program guide system 10 preferably includes a channel management module 56 and a virtual channel monitor 58. The channel management module 56 manages various aspects of the virtual channels. The channel management module 56 is described in more detail with reference to FIGS. 14-35. The virtual channel monitor 58 is described in more detail with reference to FIGS. 18-20.

The program guide information preferably includes links to a plurality of program item representations associated with the program items. The program item representations typically include: currently broadcast videos for the programs being broadcast now; promotional presentations for the programs scheduled for broadcast in the future, broadcaster pushed programs, and VOD programs; and recorded programs for viewer recorded programs. It will be appreciated by those ordinarily skilled in the art that broadcaster pushed programs and/or VOD programs can be represented by the program video. Each promotional representation is typically a promotional video clip and/or still image associated with the program item being represented. The choice of promotional video clip and/or still image is mainly dependent upon the available material for the program item being represented as well as the storage capacity and/or processing power of the set-top box 50 or the ability to obtain the promotional video clip and/or still image from the broadcast stream, from local storage, or from a remote storage device in a timely manner, for example, but not limited to, from a VOD server and/or Internet Server and/or DVD jukebox.

The electronic program guide system 10 optionally includes a banner generator 60 to generate a text banner (see FIGS. 9 and 10 for examples of the text banners) for display with each of the program item representations. The text banner is typically removed after the program item representation has been playing for a short period, for example, but not limited to, three seconds. A text banner is particularly useful when a transition screen is not used. Transition screens are described in more detail below and, in particular, with reference to FIG. 13. The text banner conveys useful information about the program, for example, but not limited to, any combination of the details described with reference to the text banner of the transition screen of FIG. 13.

The electronic program guide system 10 also preferably includes a navigation control module 62 to receive program selection instructions from the viewer 12, via the remote control 20, in order for the viewer to surf among the program item representations of the current scheduled programs. Additionally, the navigation control module 62 allows the viewer to surf, for each channel, among the following: the current scheduled program; the future scheduled programs; and the previous scheduled programs (block 64).

The term “surf”, as used in the specification and claims, is defined as moving from one program item representation to viewing another program item representation with only a single input from the viewer, for example, but not limited to depressing only one key on the remote control 20. For example, currently broadcast video of different channels is selected using either the up key 42 or the down key 18 on the remote control 20. Future scheduled program item representations are preferably selected by depressing the right key 28 on the remote control 20 and previous scheduled program item representations are preferably selected by depressing the left key 44 of the remote control 20.

The electronic program guide system 10 also preferably includes a program item display module 66 to display a currently selected one of the program item representations so that the currently selected program item representation occupies a majority (at least 50%), preferably 100%, of the screen 22 of the display device 24 (block 68).

Therefore, the viewer 12 generally uses the remote control 20 to surf among the program item representations of current scheduled, future scheduled and previous scheduled program items. The program item display module 66 preferably displays only one of the program item representations at a time, preferably providing a full screen display of the currently selected program item representation.

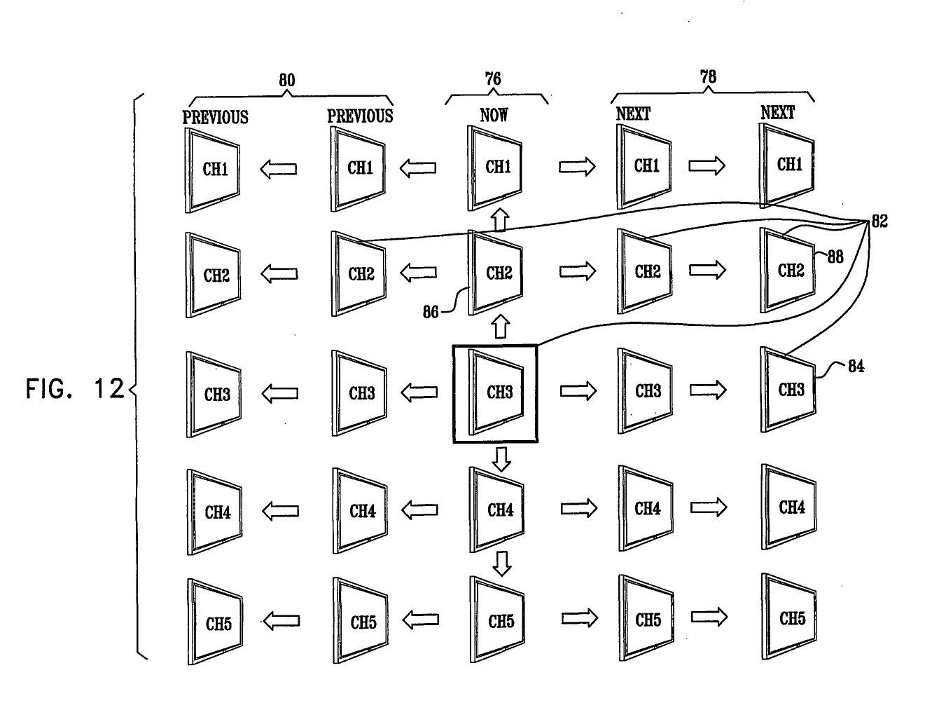

The current and future scheduled program items typically have a viewing time slot and a start time. The virtual channels, if necessary, preferably include overlapping program items having overlapping time slots. Each program item in an overlapping time slot preferably has a program item representation, which is separately viewable. The program item display module 66 is preferably adapted to display the overlapping program items based on at least one of the following: a start time of the overlapping program items; and an alphabetical sorting of the overlapping program items. However, it will be appreciated by those ordinarily skilled in the art that the program items of an overlapping time slot can be sorted in accordance with any suitable sorting method. Optionally, the program item display module 66 is adapted to display an on-screen display (not shown) including a choice of which of the overlapping program items to currently display. A virtual channel having overlapping time slot program items is described in more detail with reference to FIG. 15.

In accordance with the most preferred embodiment of the present invention, the viewer 12 is given a choice of which of the program item representations of an overlapping time slot to view.

If the overlapping program item representations relate to substantially the same item, for example, but not limited to, several near VOD program which are listed in several real channels that are also listed in one virtual channel, then the program items in the overlapping time slot are preferably represented by a single program item representation which lists the viewing times for all the program items.

The electronic program guide system 10 preferably includes a transition screen generator 70 to generate a transition screen (see FIGS. 4, 6 and 13 for examples of transition screens) for automatic display before display of each program item representation (block 72). The transition screen typically includes a pictorial representation of the currently selected program item as well as a text banner which conveys useful information about the currently selected program item. The transition screen generator 70 is typically adapted to display the transition screen for a predetermined time period, for example, 3 seconds, which can preferably be overridden by viewer input via the remote control 20. If the playout of program item representation is not yet available due to inherent latency of recording device and/or the broadcasting system the set-top box 50, then an on-screen display (not shown) is preferably displayed on top of the transition screen, informing the viewer 12 of the latency. The transition screen is described in more detail with reference to FIG. 13.

After the transition screen has been removed, the currently selected program item representation is displayed, the program item representation being selected from the following list: a promotional video or still, a recorded video, a currently broadcast video, broadcaster pushed content or a VOD item (block 74).

Items such as promotional representations (videos and stills), transition screens and banners are preferably downloaded by the broadcaster to local storage, such a hard disk drive of the set-top box 50. The downloading typically takes place overnight when spare bandwidth is generally available and the set-top box 50 has one or more free tuners for recording the downloaded data. In accordance with the most preferred embodiment of the present invention, the set-top box 50 includes a tuner which is typically a broadcaster controlled dedicated tuner for downloading the above items. If the set-top box 50 has Internet Protocol capabilities then the above items are preferably downloaded via a broadband link. In accordance with the most preferred embodiment of the present invention, the electronic program guide system 10 includes a promotional video grabber 75 to identify and record a currently broadcast (for immediate display) promotional video for use as one of the promotional representations. The above items are preferably meta-tagged so that the items are associated with programs, channels and time slots, as appropriate, so that the electronic program guide system 10 knows when and where to display the saved grabbed items.

It will be appreciated by those ordinarily skilled in the art that other standard EPG modules are typically required for the operation of the electronic program guide system 10.

It will be appreciated by those ordinarily skilled in the art that the electronic program guide system 10 can include both program item representations and transition screens for all program items, or program item representations without transition screens for all program items.

It will be appreciated by those ordinarily skilled in the art that broadcasters can employ any suitable combination of program item representations having video and/or still images, with or without text banners, and with or without transition screens, depending on various factors for example, but not limited to, bandwidth, disk space, number of available tuners to push video to disk, as well as the processing power of the set-top boxes. Different viewers may experience different EPG behavior depending on the factors of the previous list, or depending on the package to which the viewers have subscribed.

It will be appreciated by those ordinarily skilled in the art that the electronic program guide system 10 can be adapted for use with the following broadcast systems: satellite, cable, terrestrial, Internet protocol, or any suitable broadcast system, individually or in any suitable combination thereof.

Reference is now made to FIG. 12, which is partly pictorial, partly block diagram illustrating the method of operation of FIG. 11 of the electronic program guide system 10 of FIG. 1. The viewer 12 (FIG. 2) surfs among current scheduled program items 76, future scheduled program items 78 and previous scheduled program items 80 using the remote control 20 (FIG. 2). The program item display module 66 (FIG. 1) preferably displays only one of the program item representations at a time, preferably providing a full screen display 82 of the program item representations. As previously described, an appropriate transition screen is preferably displayed briefly prior to display of each program item representation.

It should be noted, that if the viewer 12 (FIG. 2) is viewing a future or previous scheduled program item representation, and then the viewer 12 (FIG. 2) decides to change to a different channel, a currently broadcast video of the newly selected channel is preferably selected by default. For example, if the viewer is viewing a program item representation of a future item 84 on channel 3, and then the viewer 12 (FIG. 2) decides to change to channel 2, a currently broadcast video 86 of channel 2 is selected for viewing.

However, it will be appreciated by those ordinarily skilled in the art that the electronic program guide system 10 can be adapted so that if the viewer 12 (FIG. 2) is viewing a future or previous scheduled program item representation, and then the viewer 12 (FIG. 2) decides to change to a different channel, the program item representation of the same or similar time slot can be selected for viewing. For example, if the viewer is viewing the program item representation of the future item 84 in channel 3, and then the viewer 12 (FIG. 2) decides to change to channel 2, the electronic program guide system 10 can be adapted to display a future scheduled program item representation 88 of channel 2.

Reference is now made to FIG. 13, which is a simplified view of a preferred embodiment of a transition screen banner 90 for use with the electronic program guide system 10 of FIG. 1. The transition screen banner 90 typically includes, as applicable, one or more items from the following list: the channel number of the currently selected channel; the channel name of the currently selected channel; the title of the currently selected program item; the start time, the end time and/or the duration of the currently selected program item; the episode number of the currently selected program item; a “viewed/not viewed/partially viewed status” of the currently selected program item; a when recorded indicator of the currently selected program item; credits of the currently selected program item; the genre of the currently selected program item; the plot outline of the currently selected program item; the booking option(s) and/or recording option(s) of the currently selected program item so that the viewer can select to book and/or record the currently selected program item; the price of the currently selected program item; the recording option(s) of the currently selected program item; a rating of the currently selected program item.

A transition screen is typically used for the following reasons.

First, a transition screen enables the viewer 12 (FIG. 2) to quickly decide whether or not to view the program or promotional presentation; this is because some TV programs do not identify themselves clearly immediately.

Second, the transition screen disguises any latency associated with playing out video from a disk, VOD server or other source, such as Internet server, or DVD jukebox. Therefore, the use of transition screens is particularly useful when there is inherent latency in the playout.

Third, the transition screen allows consistent interaction across all programs and channels even when a program item representation is not available for one or more program items. In the situation, where a program item representation is not currently available, the viewer 12 (FIG. 2) is preferably able to book the program item and/or program item representation for future viewing and/or recording. Future viewing and recording options are clearly displayed to the viewer 12 (FIG. 2).

Reference is now made to FIGS. 1, 14 and 15. FIG. 14 is a simplified flow chart of another aspect of the preferred method of operation of the electronic program guide system 10 of FIG. 1. FIG. 15 is simplified view of an electronic program guide grid 92 constructed and operative in accordance with the preferred method of operation of FIG. 14 of the electronic program guide system 10 of FIG. 1. The program guide module 52 is preferably adapted to manage program guide information (block 94) for a plurality of program items 96 for a plurality of channels 98. The program items preferably include a plurality of current scheduled programs 100, a plurality of future scheduled programs 102, a plurality of previous scheduled programs 104. The future scheduled programs 102 include a VOD program 105.

The navigation control module 62 is preferably adapted to receive program item selection instructions from the viewer 12 (FIG. 2), via the remote control 20 (FIG. 2), in order for the viewer 12 (FIG. 2) to move among the program items 96 (block 106). The program item display module 66 is preferably adapted to display the program items 96 sorted by the channels 98. The previous scheduled programs 104 are typically displayed with the channels 98 from which the previous scheduled programs 104 were scheduled. The previous scheduled programs 104 are typically displayed such that non-time adjacent previous scheduled programs 108 of one channel 110 are displayed substantially adjacent to each other (block 112).

The term “non-time adjacent previous scheduled programs”, as used in the specification and claims, is defined herein as programs which would not be adjacent to each other in time even if non-programming material, for example, but not limited to, commercials, were removed.

The term “substantially adjacent to each other” is defined herein as not being separated in the same channel, spatially nor physically in the EPG, by another program item, except for non-programming material, for example, but not limited to, commercials.

Some of the program items 96 have associated prices 114. By way of example only, the prices 114 of the program items 96 are within a price range of $5 to $15. The channels 98 include a virtual channel 116. The virtual channel 116 is preferably managed by the channel management module 56 such that the prices of all the program items 96 displayed in the virtual channel 116 are within a narrow price range, for example, prices up to $10 (block 118). It should be noted that the virtual channel 116 also includes a VOD program (Gremlins 3) which was selected from a VOD directory for inclusion in the virtual channel 116.

Each of the program items 96 has a viewing time slot 120. In virtual channel 116, for example, the viewing time slots of three program items 96 (namely, Anaconda, Ghost Stories and Adventure Racing in the example of FIG. 15) overlap. Therefore, the program item display module 66 is preferably adapted to display the virtual channel 116 such that the three overlapping program items 96 share a single expandable slot 122 in the virtual channel 116 (block 124).

The electronic program guide system 10 also preferably includes a list box display module 126 to display a listbox 128 when the expandable slot is selected by the viewer 12 (FIG. 2) for expansion. The listbox 128 includes the three overlapping program items 96 for viewing and/or selection.

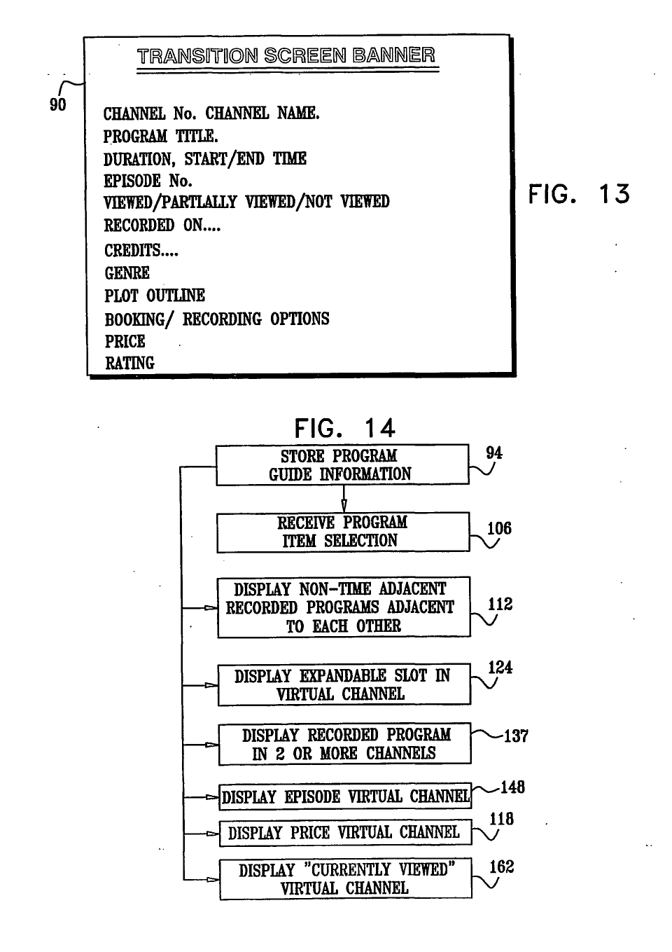

Reference is now made to FIGS. 1, 14 and 16. FIG. 16 is simplified view of an electronic program guide grid 130 constructed and operative in accordance with the preferred method of operation of FIG. 14.

The electronic program guide grid 130 preferably includes a plurality of channels 132 preferably including a plurality of real channels 134 and a plurality of virtual channels 136. The program item display module 66 is preferably adapted to display, when necessary, one or more of the previous scheduled programs, both in one of the real channels 132 and in one or more of the virtual channels 136 (block 137). In the example of FIG. 16, a plurality of recorded programs 138 are shown in real channel 7 as well as in the Eastenders virtual channel and in the Soaps virtual channel.

The electronic program guide grid 130 includes a plurality of program items 140 which include a plurality of episodes of a series 142, Eastenders in the example of FIG. 16. The episodes of a series 142 also include the recorded programs 138.

The channel management module 56 is preferably adapted to create and manage one of the virtual channels 136, virtual channel (Eastenders) in the example of FIG. 16, for episodes of a series 142 such that all the program items 140 displayed in the virtual channel are the episodes of the same series 142 including the recorded programs 138 (block 148). The recorded programs 138 are preferably sorted in the virtual channel 136 by episode number.

In accordance with the most preferred embodiment of the present invention, a virtual channel of episodes is preferably created when the viewer 12 (FIG. 2) has recorded a certain number, for example, but not limited to 3, episodes of one series.

In accordance with the most preferred embodiment of the present invention, programs that have been recorded but do not make up a series channel, such as individual episodes, one-off documentaries, can be organized into virtual channels of predetermined categories, for example, but not limited to: genres, such as soaps, action films, comedy, kids films, dramas and talk shows; or other attributes as defined by the viewer, such as films directed by Stephen Spielberg.

In accordance with a preferred embodiment of the present invention, virtual channels are preferably created based on: a viewer search; and/or based on previous routine viewing patterns (for example, the viewer 12 (FIG. 2) always watches a particular soap on Monday at 7 pm and news at 9 pm) and program preferences.

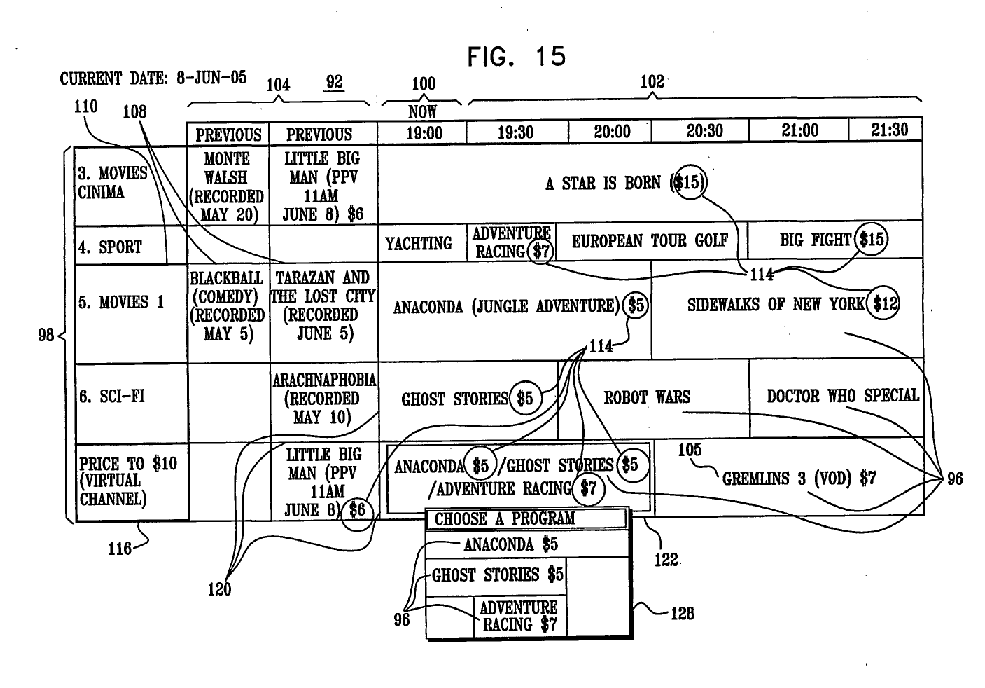

Reference is now made to FIGS. 1, 14 and 17. FIG. 17 is simplified view of an electronic program guide grid 150 constructed and operative in accordance with the preferred method of operation of FIG. 14. The electronic program guide grid 150 preferably includes a plurality of program items 152 for a plurality of channels 154. The channels 154 include a plurality of real channels 156 and a virtual channel 158.

The channel management module 56 is preferably adapted to manage the virtual channel 158 such that all the program items 152 displayed in the virtual channel 158 are associated with a program characteristic of a currently viewed program item 160 (block 162). The term “program characteristic”, as used in the specification and claims, is defined as a characteristic of a program item other than the channel with which the program item is associated with.

In the example of FIG. 17, the currently viewed program item 160 is “Ants of Africa” presented by David Attenborough on Variety Channel 2. The virtual channel 158 includes the program items 152 related to at least part of the name of the currently viewed program item 160. Therefore, the virtual channel 158 includes programs with titles relating to insects. However, it will be appreciated by those ordinarily skilled in the art that other characteristics of the currently viewed program item 160 can be used to create a virtual channel, for example, but not limited to, creating a virtual channel based on the genre of the currently viewed program item 160 (in the example of FIG. 17, documentary or nature) or based on an attribute of the currently viewed program item 160 (in the example of FIG. 17, programs presented by David Attenborough).

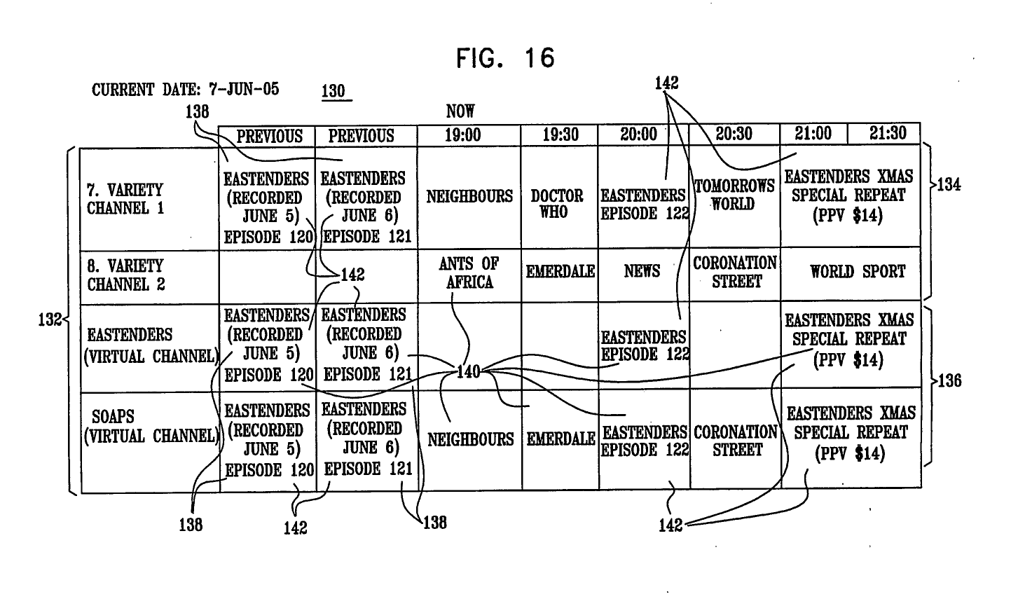

Reference is now made to FIGS. 18 and 19. FIG. 18 is a simplified flow chart of yet another aspect of the preferred method of operation of the electronic program guide system 10 of FIG. 1. FIG. 19 is a simplified view of an electronic program guide grid 164 constructed and operative in accordance with the preferred method of operation of FIG. 18. Reference is also made to FIG. 1. The program guide module 52 is preferably adapted to manage program guide information for a plurality of program items 166 for a plurality of channels 168 (only one shown in FIG. 19) (block 170).

The program items 166 typically include a plurality of current scheduled programs 172 (only one current scheduled program 172 is shown in FIG. 19), a plurality of future scheduled programs 174 and a plurality of recorded programs 176. The channel management module 56 is preferably adapted to manage a virtual channel 178 such that all the program items 166 displayed in the virtual channel 178 have a first program characteristic (block 180). In the example of FIG. 19, the first program characteristic is the genre of “films”. The program items 166 displayed in the virtual channel 178 typically include one or more of the recorded programs 176, one of the current scheduled programs 172 and one or more of the future scheduled programs 174.

The virtual channel monitor 58 is preferably adapted to monitor a size of the virtual channel 178 (block 182). The size of the virtual channel 178 is preferably measured by a number of the recorded programs 176 displayed in the virtual channel 178. When the size of the virtual channel 178 grows to a predetermined size (in the example of FIG. 19, when the recorded programs reach 5 recorded programs, by recording “The good, the bad and the ugly”), the channel management module 56 creates a new virtual channel 184 to receive some of the program items of the virtual channel 178, thereby reducing the size of the virtual channel 178 (block 186).

All the program items displayed in the new virtual channel 184 have a second program characteristic, which is a sub-category of the first program characteristic. In the example of FIG. 19, the second program characteristic is the genre of “western films” which is a sub-category of “films”.

The original virtual channel 178 is preferably renamed as a “general film” virtual channel having a revised program characteristic of all films excluding westerns (block 187). Alternatively, the virtual channel 178 is deleted and a new “general film” virtual channel is created. In other words, the original virtual channel 178 is split into the virtual channel 184 and a new general film virtual channel (block 189).

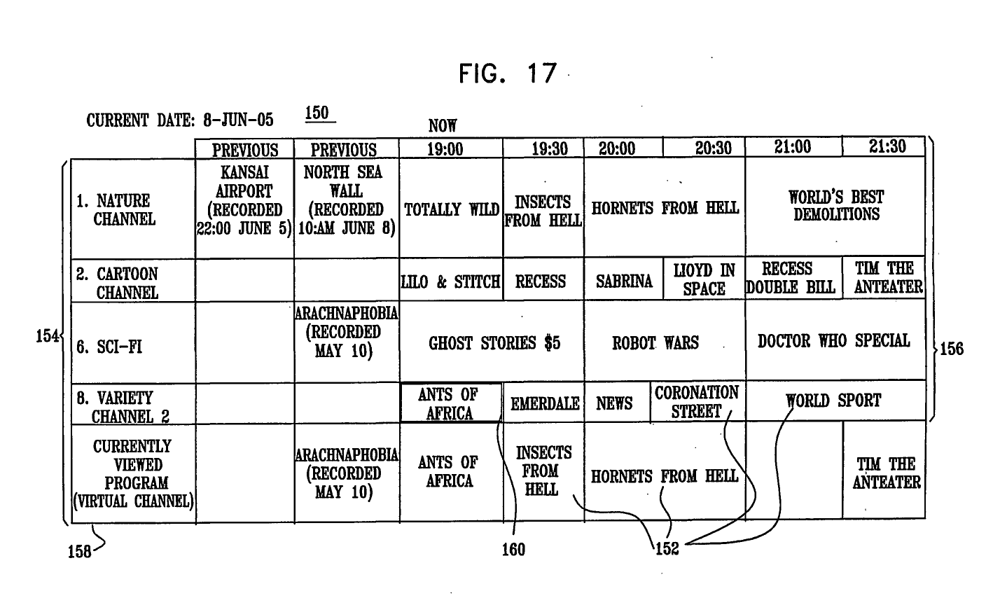

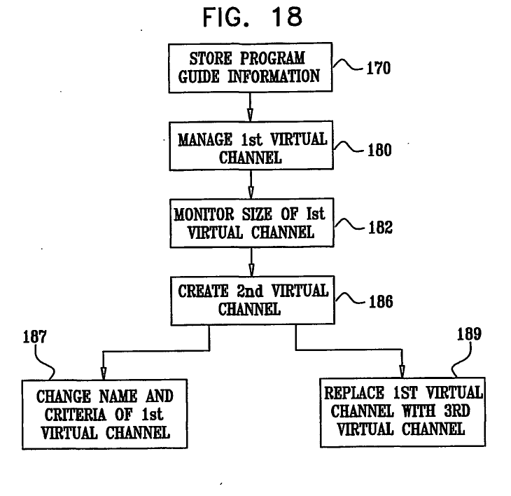

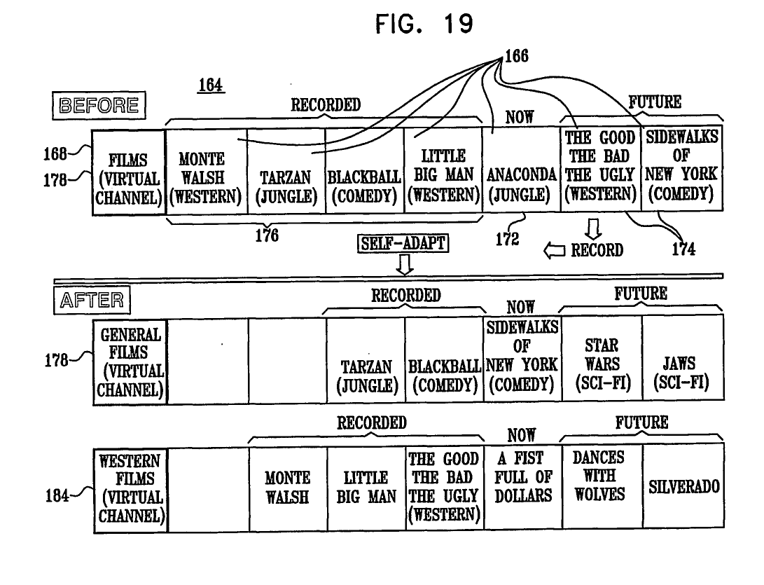

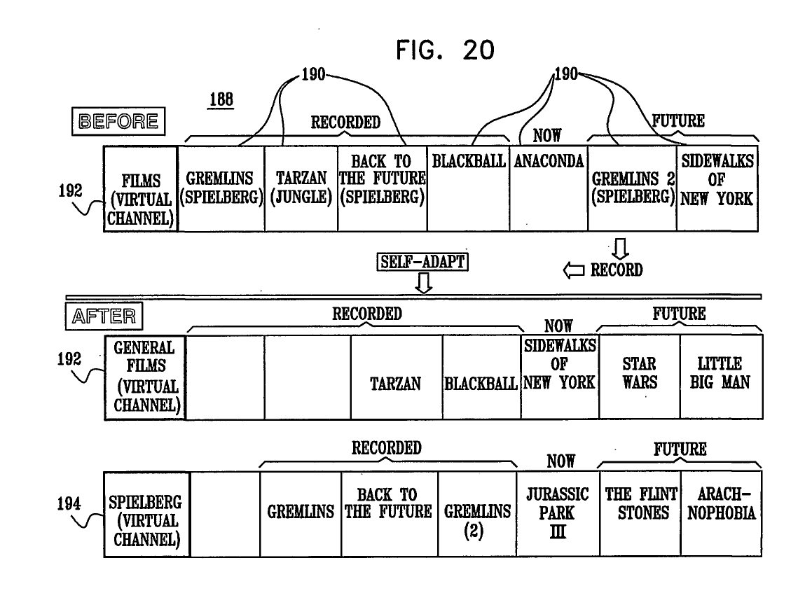

Reference is now made to FIG. 20, which is a simplified view of an electronic program guide grid 188 constructed and operative in accordance with the preferred method of operation of FIG. 18. Reference is also made to FIG. 1. The electronic program guide grid 188 includes a plurality of program items 190 and a film virtual channel 192. After “Gremlins 2” is recorded, the channel management module 56 creates a new virtual channel 194. All the program items 190 displayed in the new virtual channel 194 have a program characteristic, which is a sub-category of the program characteristic of the film virtual channel 192. In the example of FIG. 19, the second program characteristic is an attribute of “Spielberg as producer” which is different from the original characteristic of the original film virtual channel 192 which was “genre of films”.

The original virtual channel 192 is preferably renamed as a “general film” virtual channel having a revised program characteristic of all films excluding Spielberg as producer (block 187). Alternatively, the virtual channel 192 is deleted and a new “general film” virtual channel is created. In other words, the original virtual channel 192 is split into the virtual channel 194 and a new general film virtual channel (block 189).

In accordance with the most preferred embodiment of the present invention, one or more virtual channels of predetermined categories are preferably created when there are a minimum number of recorded program items, for example 3, in the predetermined categories, respectively. If the number of recorded programs in a virtual channel falls below a predetermined minimum monitored by the virtual channel monitor 58, for example 2, then the programs of the virtual channel are preferably added to a more general suitable virtual channel by the channel management module 56. The general suitable virtual channel may be a suitable existing virtual channel or a newly created virtual channel to merge therein the program items of two or more existing virtual channels. It should be noted that the general suitable virtual channel may be the original virtual channel that split, for example, the movie virtual channel splits into two virtual channels, such as a romance movie virtual channel and a comedy movie virtual channel, the two virtual channels then merge back into the single movie virtual channel.

If the number of recorded programs exceeds a predetermined number, for example 5, then the virtual channel splits into two virtual channels, one of the channels generally being the original virtual channel. For example, when 3 films are recorded, a film channel is created. When there are 5 recorded films, the virtual channel divides into an action film virtual channel and another general film virtual channel. When the action film virtual channel has 5 recorded films, the action film virtual channel splits into a war film virtual channel and a martial art film virtual channel, etc.

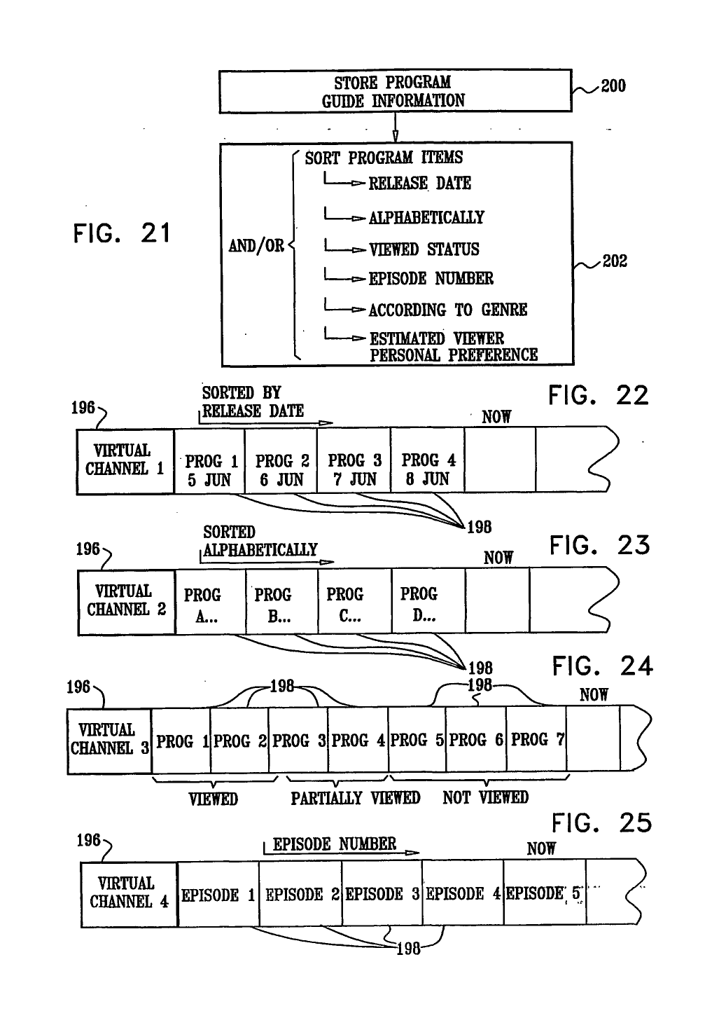

Reference is now made to FIGS. 21-26. FIG. 21 is a simplified flow chart of a further aspect of the preferred method of operation of the electronic program guide system 10 of FIG. 1. FIGS. 22-26 are simplified views of virtual channels 196 constructed and operative in accordance with the preferred method of operation of FIG. 21. Reference is also made to FIG. 1. As described above with reference to FIG. 1, the program guide module 52 is preferably adapted to manage program guide information for a plurality of program items 198 for a plurality of channels including the virtual channels 196 (block 200). The channel management module 56 is preferably adapted to order the recorded program items 198 of the virtual channel 196 for display based on at least one of the following: a release date of the recorded program items 198 (FIG. 22); an alphabetical sorting of the recorded program items 198 (FIG. 23); a viewed/not-viewed/partially-viewed status of the recorded program items 198 (FIG. 24); an episode number of the recorded program items 198 (FIG. 25); and an estimated viewer personal preference (block 202). The estimated viewer personal preference is preferably determined by the channel management module 56. For example, the channel management module 56 knows that the viewer watches the shorter recorded movies first. Therefore, the shortest movies are closest to the “NOW” position in the grid. The examples of FIGS. 21-26 have been described with reference to ordering recorded programs in a virtual channel. However, it will be appreciated by those ordinarily skilled in the art that the ordering can be performed on recorded program items of a real channel.

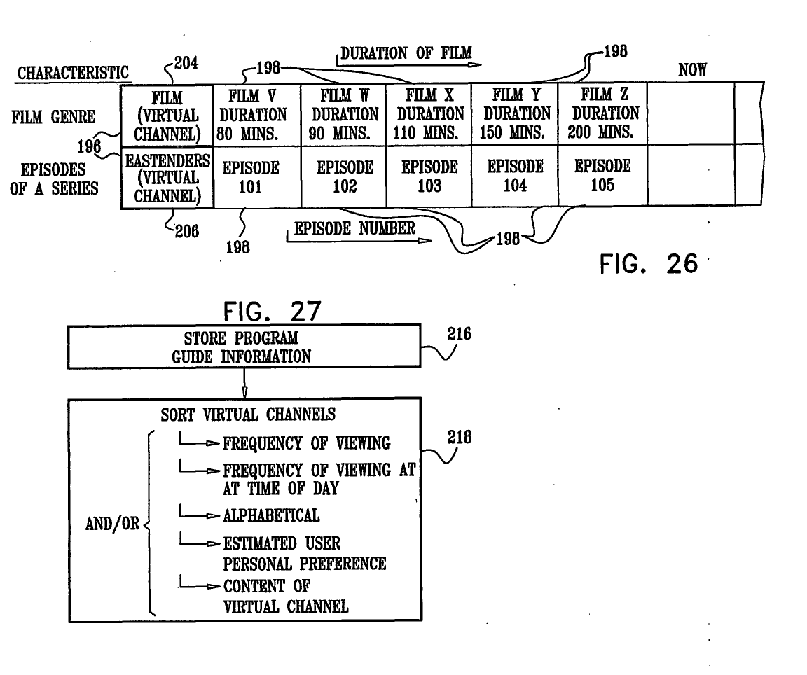

FIG. 26 shows two virtual channels 196 where the recorded program items 198 are ordered by the channel management module 56 based on an ordering method which is preferably dependent upon a characteristic of the virtual channel. In the example of FIG. 26, the recorded program items 198 of a film virtual channel 204 (having a genre of films) are preferably sorted by the duration of the film, with the shortest films appearing first in the virtual channel; the recorded program items 198 of an Eastenders virtual channel 206 (a virtual channel of episodes of a series) are preferably sorted by episode number.

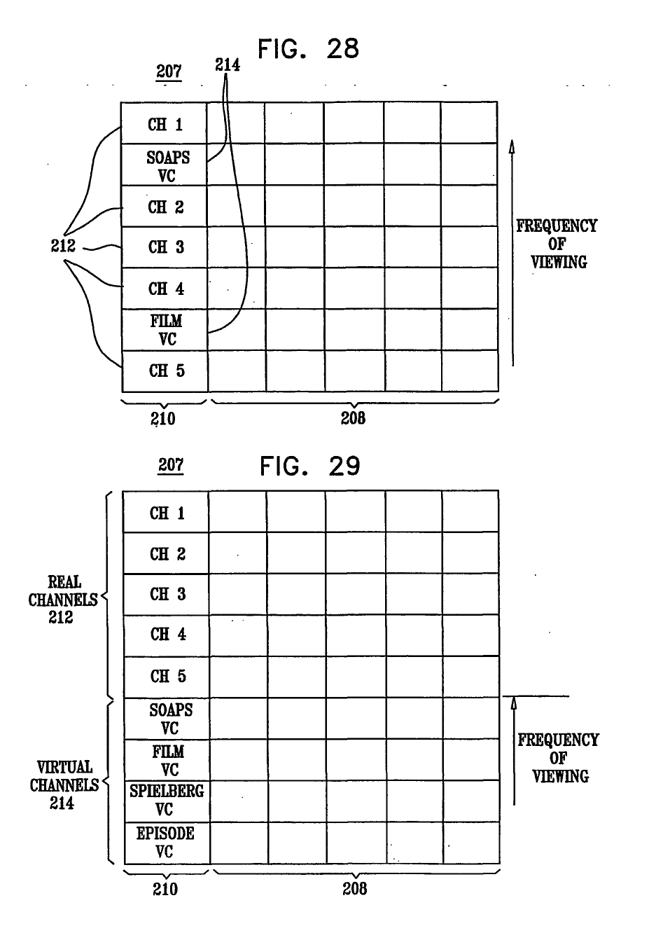

Reference is now made to FIGS. 27-35. FIG. 27 is a simplified flow chart of an additional aspect of the preferred method of operation of the electronic program guide system 10 of FIG. 1. FIGS. 28-35 are simplified views of electronic program guide grids 207 constructed and operative in accordance with the preferred method of operation of FIG. 27 (for the sake of clarity, program titles have generally not been shown in FIGS. 28-35). Reference is also made to FIG. 1. As described above with reference to FIG. 1, the program guide module 52 is preferably adapted to manage program guide information for a plurality of program items 208 for a plurality of channels 210 including a plurality of real channels 212 and one or more virtual channels 214 (block 216). The channel management module 56 is preferably adapted to order the virtual channels 214 for display among the channels 210 according to at least one of the following sorting methods: content of the virtual channel 214, frequency of viewing of the program items 208 of the virtual channel 214, frequency of viewing at a time of day, alphabetical sorting by a name of the virtual channel 214, and an estimated viewer personal preference (block 218). These sorting methods are described in more detail below.

The channel management module 56 is preferably adapted to order the virtual channels 214 for display among the real channels 212 as shown in FIGS. 28, 30, 32, 34 and 35. However, according to an alternative preferred embodiment of the present invention the channel management module 56 is preferably adapted to order the virtual channels 214 for display only among the other virtual channels 214 as shown in FIGS. 29, 31 and 33. The term “display only among”, as used in the specification and claims, is defined as displaying the virtual channels in a group which is separate from the real channels.

It will be appreciated by those ordinarily skilled in the art that other suitable sorting combinations are possible, for example, but not limited to, sorting the real channels among themselves, or sorting all the channels (real and virtual) together as a single unified group.

Reference is now made to FIG. 28. FIG. 28 shows the virtual channels 214 sorted by frequency of viewing the program items 208 among the real channels 212.

Reference is now made to FIG. 29. FIG. 29 shows the virtual channels 214 sorted by frequency of viewing the program items 208 for display only among the other virtual channels 214.

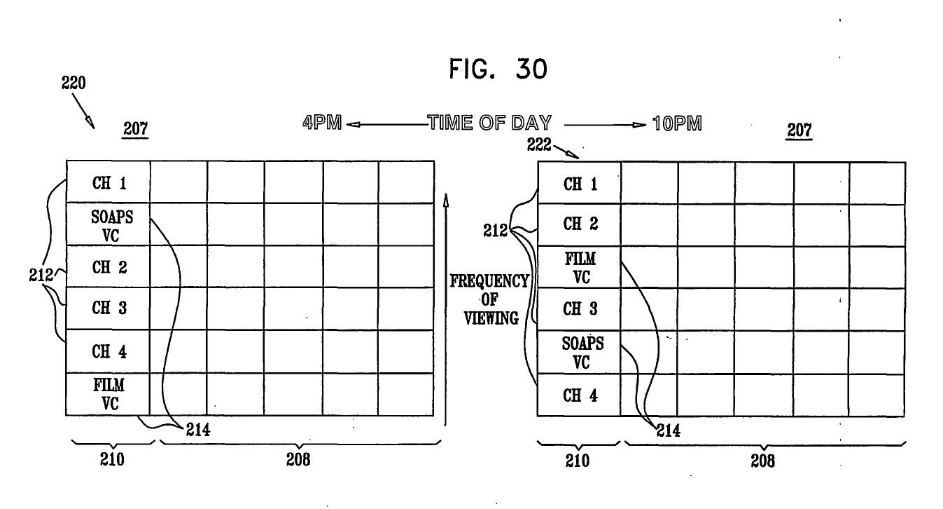

Reference is now made to FIG. 30. FIG. 30 shows a first sorting 220 of the virtual channels 214 sorted by a frequency of viewing at 4 pm among the real channels 212, and a second sorting 222 of the virtual channels 214 sorted by a frequency of viewing at 10 pm, among the real channels 212.

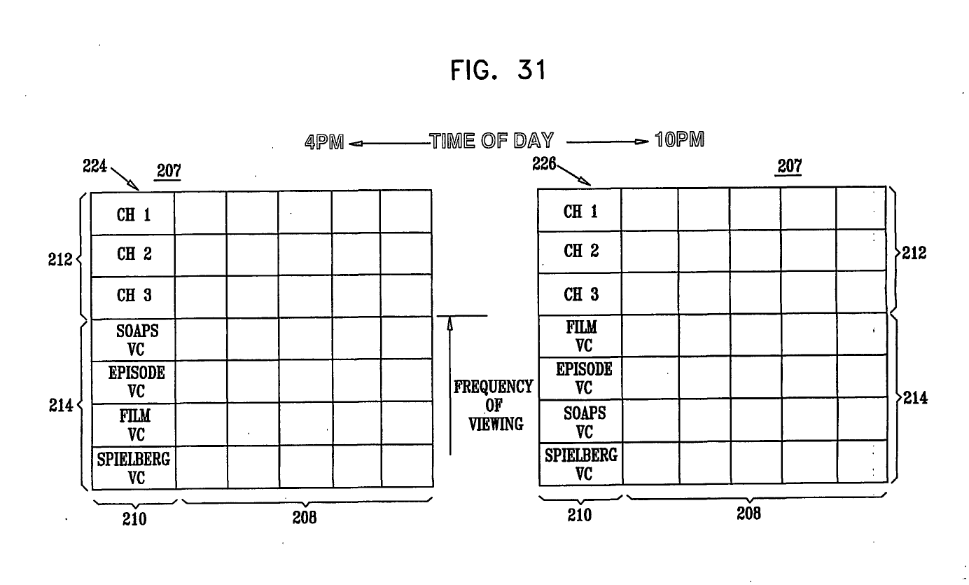

Reference is now made to FIG. 31. FIG. 31 shows a first sorting 224 of the virtual channels 214 sorted by a frequency of viewing at 4 pm for display only among the other virtual channels 214, and a second sorting 226 of the virtual channels 214 sorted by a frequency of viewing at 10 pm for display only among the other virtual channels 214.

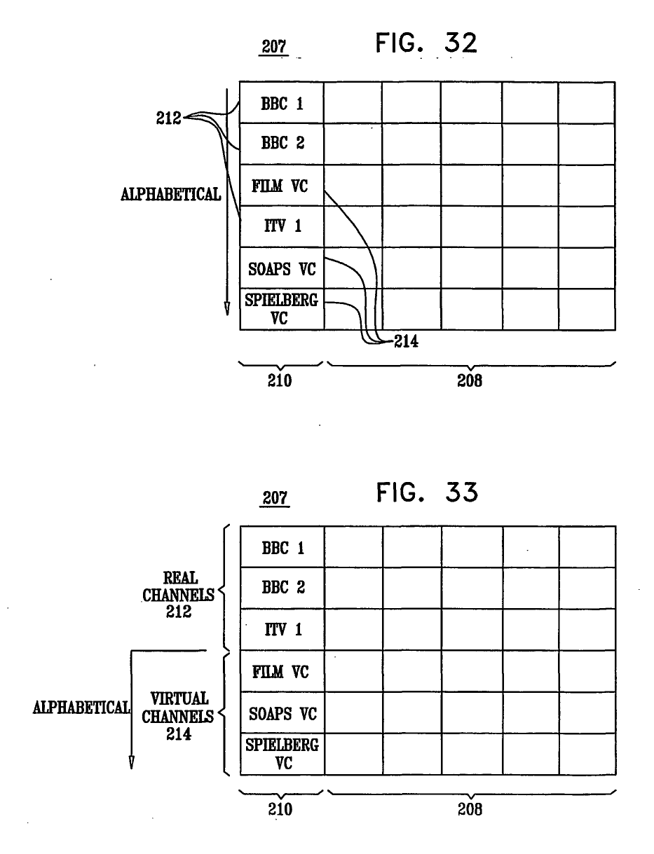

Reference is now made to FIG. 32. FIG. 32 shows the virtual channels 214 sorted alphabetically, by a name of the virtual channel 214, interleaved among the real channels 212.

Reference is now made to FIG. 33. FIG. 33 shows the virtual channels 214 sorted alphabetically, by a name of the virtual channel 214, for display only among the virtual channels 214 such that all the virtual channels 214 are listed below the real channels 212.

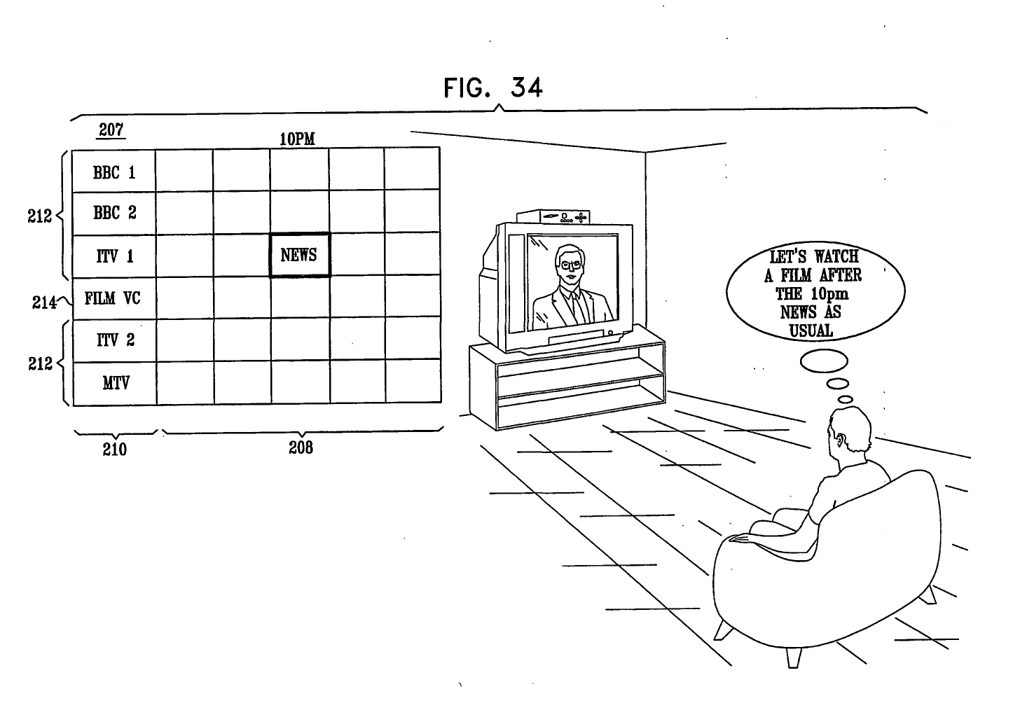

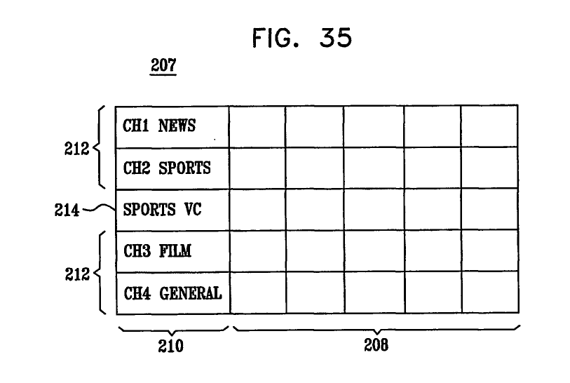

Reference is now made to FIG. 34. FIG. 34 shows the virtual channel 214, “Film VC” in the example of FIG. 34, ordered according to an estimated viewer personal preference. In the example of FIG. 34 the channel management module 56 knows that in a majority of cases the viewer 12 (FIG. 2) watches a film after the 10 pm News on ITV1. Therefore, the channel management module 56 is preferably adapted so that the “Film VC” is adjacent to ITV1 at 10 pm.

It will be appreciated by those ordinarily skilled in the art that other suitable estimated viewer personal preferences can be used to order one or more of the virtual channels 214 among either the real channels 212 or only among the other virtual channels 214.

Reference is now made to FIG. 35. FIG. 35 shows the virtual channel 214, “Sports VC” in the example of FIG. 35, next to a real channel of similar content, “Ch2 Sports”. Positioning a virtual channel adjacent to a real channel of similar content is typically based on meta-data of the channels and/or the meta-data of the program items within the channels.

In accordance with the most preferred embodiment of the present invention, the electronic program guide system 10 typically includes functions to enable the viewer 12 (FIG. 2) to: manually order, create and delete virtual channels; and create rules for automatic creating, splitting and deletion of virtual channels. For example, a rule could be created to delete virtual channels that have not been viewed in more than 2 weeks.

Additionally, virtual channels are optionally assigned a fixed number for remote control access to speed up access to virtual channels.

It will be appreciated that the virtual channels of FIG. 14-35, as appropriate, can be displayed in a conventional EPG grid, or displayed using the electronic program guide system 10 according to the preferred embodiment of FIGS. 1-13.

It will be understood that the system according to the present invention may be a suitably programmed processor. Likewise, the invention contemplates software being readable by a processor for executing the method of the invention. The invention further contemplates a machine-readable memory tangibly embodying a program of instructions executable by the machine for executing the method of the invention.

It will be appreciated that various features of the invention which are, for clarity, described in the contexts of separate embodiments may also be provided in combination in a single embodiment. For example, it will be appreciated that one or more of the various features of the embodiment of FIGS. 1-13 may be implemented into a system typically including one or more of the various suitable features of the embodiment of FIGS. 14 to 35.

Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1-84. (canceled)

85. A system for a viewer to navigate television programming using a control, the television programming being viewable on a display device having a screen, the system comprising:
a program guide module to manage program guide information for a plurality of program items for a plurality of channels, the program items including a plurality of current scheduled programs and a plurality of future scheduled programs, the program guide information including a plurality of links to a plurality of program item representations associated with the program items;
a program item display module to display any of the program item representations as occupying a majority of the screen of the display device; and
a navigation control module to receive program selection instructions from the viewer, via the control, in order for the viewer to surf, for each of the channels, among the program item representations of one of the current scheduled programs and at least two of the future scheduled programs, surfing being moving from a majority screen display of one of the program item representations to viewing a majority screen display of another one of the program item representations with a single input from the viewer.

86. The system according to claim 085, wherein the program item representations include a plurality of currently broadcast videos for the current scheduled programs and a plurality of promotional representations for the future scheduled programs.

87. The system according to claim 86, wherein at least one of the promotional representations is a promotional video associated with a corresponding one of the future scheduled programs.

88. The system according to claim 86, wherein each of the promotional representations includes at least one of a promotional video clip and a still image, the promotional video clip and the still image being associated with a corresponding one of the future scheduled programs.

89. The system according to claims 85, wherein surfing is moving from a full screen display of one of the program item representations to viewing a full screen display of another one of the program item representations with only a single input from the viewer.

90. The system according to claim 85, wherein the program item display module is adapted to display only one of the program item representations at a time.

91. The system according to claim 85, wherein:
the program items include at least one previous scheduled program being associated with one of the program item representations; and
the navigation control module being adapted to receive the program selection instructions from the viewer, via the control, in order for the viewer to surf among the program item representations of one of the current scheduled programs and the at least one previous scheduled program.

92. The system according to claim 91, wherein the at least one previous scheduled program includes a recorded program.

93. The system according to claim 85, wherein the channels include a virtual channel.

94. The system according to claim 93, wherein the program items of the virtual channel include at least one video-on-demand program.

95. The system according to claim 93, wherein:
each of the program items has a viewing time slot and a start time; and
in the virtual channel, the program items includes a plurality of overlapping program items such that the viewing time slot of a first one of the program items overlaps with the viewing time slot of a second one of the program items in the virtual channel.

96. The system according to claim 95, wherein the program item display module is adapted to display the overlapping program items based on a start time of the overlapping program items.

97. The system according to claim 95, wherein the program item display module is adapted to display the overlapping program items based on an alphabetical sorting of the overlapping program items.

98. The system according to claim 95, wherein the program item display module is adapted to display an on-screen-display including a choice of which of the overlapping program items to currently display.

99. The system according to claim 85, further comprising a transition screen generator to generate a transition screen for display before display of each of the program item representations.

100. A method for a viewer to navigate television programming using a control, the television programming being viewable on a display device having a screen, the method comprising:
managing program guide information for a plurality of program items for a plurality of channels, the program items including a plurality of current scheduled programs and a plurality of future scheduled programs, the program items being represented by a plurality of program item representations, the program guide information including a plurality of links to the program item representations;
displaying each of the program item representations as occupying a majority of the screen of the display device; and
receiving program selection instructions from the viewer, via the control, in order for the viewer to surf, for each of the channels, among the program item representations of one of the current scheduled programs and at least two of the future scheduled programs, surfing being moving from a majority screen display of one of the program item representations to viewing a majority screen display of another one of the program item representations with only a single input from the viewer.

101. A system for a viewer to navigate television programming using a control means, the television programming being viewable on a display means, the system comprising:
means for managing program guide information for a plurality of program items for a plurality of channels, the program items including a plurality of current scheduled programs and a plurality of future scheduled programs, the program guide information including a plurality of links to a plurality of program item representations associated with the program items;
means for displaying any of the program item representations as occupying a majority of a screen of the display means; and
means for receiving program selection instructions from the viewer, via the control means, in order for the viewer to surf, for each of the channels, among the program item representations of one of the current scheduled programs and at least two of the future scheduled programs, surfing being moving from a majority screen display of one of the program item representations to viewing a majority screen display of another one of the program item representations with a single input from the viewer.
